(19) United States
(12) Patent Application Publication
(10) Pub. No.: US 2025/0245711 A1
(43) Pub. Date: Jul. 31, 2025

(54) SYSTEMS AND METHODS FOR GENERATING DATA PRODUCTS PERSONALIZED TO USERS

(71) Applicant: Olympus Technologies Inc., Miami Beach, FL (US)

(72) Inventors: Jesse Halpern, Miami, FL (US); Soren Larson, Miami Beach, FL (US)

(73) Assignee: Olympus Technologies Inc., Miami Beach, FL (US)

(21) Appl. No.: 18/907,403

(22) Filed: Oct. 4, 2024

Related U.S. Application Data
(60) Provisional application No. 63/626,790, filed on Jan. 30, 2024.

(51) Int. Cl. G06Q 30/0601; G06F 40/35

(52) U.S. Cl. CPC G06Q 30/0621; G06F 40/35

(57) ABSTRACT

The techniques described herein relate to systems and methods for generating data products personalized to users. An example system includes at least one hardware processor and at least one computer-readable storage medium storing processor-executable instructions that, when executed, cause the hardware processor(s) to perform a method comprising receiving, from a service provider, a request for a data product personalized to a user and comprising (i) first information identifying or that can be used to identify data source(s) storing user data for the user that the user has authorized for access and (ii) second information indicating how to transform at least some of the user data to generate the data product, obtaining, using the second information, the at least some of the user data from, or previously retrieved from, the data source(s), generating, using the second information, the data product, and providing, to the service provider, the generated data product.

### RELATED APPLICATION

This application claims priority under 35 U.S.C. § 119 to U.S. Provisional Application No. 63/626,790, entitled “SYSTEMS AND METHODS FOR GENERATING DATA PRODUCTS PERSONALIZED TO USERS,” filed on Jan. 30, 2024, which is herein incorporated by reference in its entirety.

### FIELD

The techniques described herein relate generally to data privacy and, more particularly, to systems and methods for generating data products personalized to users.

### BACKGROUND

Online entities, such as e-commerce websites and social media networks, generate and store data related to interactions with their users. For example, an e-commerce website may generate and store information related to which item(s) from an e-commerce catalog a user clicks, views, and/or purchases. Users may be requested to share their previously generated data when visiting a new online entity, who may intend to provide content to the user in accordance with the user's past online behavior and/or preferences.

### SUMMARY

In accordance with the disclosed subject matter, systems and methods are provided for generating data products personalized to users.

Some embodiments relate to a system for generating, by a data product personalization service and for a service provider, a data product personalized to a user with whom the service provider is to interact. The system comprises at least one hardware processor, and at least one computer-readable storage medium storing processor-executable instructions that, when executed by the at least one hardware processor, cause the at least one hardware processor to perform a method. The method comprises: (A) receiving, from the service provider and via at least one communication network, a request for the data product personalized to the user, the request comprising: (i) information identifying or that can be used to identify at least one data source storing user data for the user that the user has authorized the data product personalization service to access; and (ii) information indicating how to transform at least some of the user data to generate the data product personalized to the user; (B) obtaining, using the information identifying or that can be used to identify the at least one data source, the at least some of the user data from, or previously retrieved from, the at least one data source; (C) generating, using the information indicating how to transform the at least some of the user data and a data transformation service, the data product personalized to the user; and (D) providing, to the service provider and via the at least one communication network, the generated data product personalized to the user.

Some embodiments relate to at least one computer-readable storage medium storing processor-executable instructions that, when executed by at least one hardware processor, cause the at least one hardware processor to perform a method for generating, by a data product personalization service and for a service provider, a data product personalized to a user with whom the service provider is to interact. The method comprises: (A) receiving, from the service provider and via at least one communication network, a request for the data product personalized to the user, the request comprising: (i) information identifying or that can be used to identify at least one data source storing user data for the user that the user has authorized the data product personalization service to access; and (ii) information indicating how to transform at least some of the user data to generate the data product personalized to the user; (B) obtaining, using the information identifying or that can be used to identify the at least one data source, the at least some of the user data from, or previously retrieved from, the at least one data source; (C) generating, using the information indicating how to transform the at least some of the user data and a data transformation service, the data product personalized to the user; and (D) providing, to the service provider and via the at least one communication network, the generated data product personalized to the user.

Some embodiments relate to a method for generating, by a data product personalization service and for a service provider, a data product personalized to a user with whom the service provider is to interact. The method comprises: using software of the data product personalization service executing on at least one computer hardware processor to perform: (A) receiving, from the service provider and via at least one communication network, a request for the data product personalized to the user, the request comprising: (i) information identifying or that can be used to identify at least one data source storing user data for the user that the user has authorized the data product personalization service to access; and (ii) information indicating how to transform at least some of the user data to generate the data product personalized to the user; (B) obtaining, using the information identifying or that can be used to identify the at least one data source, the at least some of the user data from, or previously retrieved from, the at least one data source; (C) generating, using the information indicating how to transform the at least some of the user data and a data transformation service, the data product personalized to the user; and (D) providing, to the service provider and via the at least one communication network, the generated data product personalized to the user.

The foregoing summary is not intended to be limiting. Moreover, various aspects of the present disclosure may be implemented alone or in combination with other aspects.

### BRIEF DESCRIPTION OF FIGURES

Various aspects and embodiments will be described with reference to the following figures. It should be appreciated that the figures are not necessarily drawn to scale. Items appearing in multiple figures are indicated by the same or a similar reference number in all the figures in which they appear.

FIG. 1A is a system for generating, by a personalization service and for a service provider, a data product personalized to a user with whom the service provider is to interact, in accordance with some embodiments of the technology described herein.

FIG. 1B is an example implementation of the system of FIG. 1A for generating a data product requested by an example service provider, in accordance with some embodiments of the technology described herein.

FIG. 2 shows a portion of the system of FIG. 1A to implement an example workflow for retrieving certain user data from specific third parties having data of a user, in accordance with some embodiments of the technology described herein.

FIG. 3 shows a portion of the system of FIG. 1A to implement an example workflow for authorizing a service provider to receive data products personalized to a user, in accordance with some embodiments of the technology described herein.

FIG. 4A shows a block diagram of an example implementation of the personalization service of at least FIG. 1A to execute a workflow for retrieving certain user data from specific third parties having data of a user, in accordance with some embodiments of the technology described herein.

FIG. 4B shows the example implementation of the personalization service shown in FIG. 4A to execute a workflow for authorizing a service provider to request data products personalized to a user, in accordance with some embodiments of the technology described herein.

FIG. 4C shows the example implementation of the personalization service shown in FIG. 4A to execute a workflow for generating a data product personalized to a user, in accordance with some embodiments of the technology described herein.

FIG. 5 is an example data flow diagram with corresponding example pseudocode for generating a data product personalized to a user, in accordance with some embodiments of the technology described herein.

FIG. 6 is a flowchart representative of an example process that may be performed and/or example machine-readable instructions that may be executed by processor circuitry to implement the personalization service of at least FIG. 1A for generating a data product personalized to a user, in accordance with some embodiments of the technology described herein.

FIG. 7 is an example electronic platform structured to execute the machine-readable instructions of FIG. 6 to implement the personalization service of at least FIG. 1A, in accordance with some embodiments of the technology described herein.

### DETAILED DESCRIPTION

Human users routinely interact with online entities for various purposes. Example purposes include consuming media (e.g., articles, music, movies, videos), shopping for products and/or services from a service provider, interacting with a social media network, and, more generally, Internet browsing. These online entities typically generate and store user data related to their interactions with users.

“User data” may refer to data that is generated in association with a user's online activity. User data may include data that is generated locally on a device of the user. Examples of such user data include a uniform resource locator (URL) of a visited website, location data of the user device such as Global Positioning System (GPS) data, browser search history, and photo and/or video metadata. User data may include data that is generated by an online entity in response to user activity. Examples of such user data include indications of a user liking or resharing social media posts, identifications of products that the user viewed on an e-commerce website, and identifications of news articles accessed by the user. Examples of user data may also refer to data that the user has licensed and/or subscribed to.

By way of example, a user may engage with a social media network such as by liking a post associated with a product, such as shoes, on INSTAGRAM®. INSTAGRAM® may generate and store user data related to the user's liking of the post. The user may also engage with another online entity, such as an e-commerce website like AMAZON®. AMAZON® may request the user to share their INSTAGRAM® data with AMAZON® such that AMAZON® may recommend products to the user that align with their interests, such as other styles of shoes that may align with the user's interests.

The inventors have recognized multiple problems faced by users and service providers with conventional user data sharing techniques. First, if a user does not share their user data with a service provider, the user suffers from unhelpful and/or suboptimal product and/or service offerings from the service provider because the service provider is providing recommendations using projections of limited available user data (e.g., clickstream data). For example, if the user does not share their INSTAGRAM® data with AMAZON®, AMAZON® may provide random recommendations, such as for cookware instead of shoes or other clothing items.

Second, if a user does share their user data with a service provider, the recommended product and/or service offerings may still be unhelpful and/or suboptimal. For example, the service provider may be unable to transform the user's data into a useful result and, instead, may simply provide overly broad and general recommendations based on the user's data. In such an example, the user's data may indicate that the user has purchased a coffee maker. The service provider in such an example may, based on the user's purchase history, provide a recommendation for another similar coffee maker or even the same coffee maker. However, the user already has a coffee maker and may not need another.

Third, if a user does share their user data with a service provider, the user does not have control over which portion(s) of their user data is/are shared with the service provider. Put another way, the user typically has no other choice but to authorize a complete data dump from a third party having data of the user to the service provider. For example, the user may have no choice but to authorize all their INSTAGRAM® data to be shared with AMAZON® rather than portion(s) thereof. Fourth, if a user does share their user data with a service provider, there is typically no technological mechanism to enable the user to revoke access to their user data because the user data has already been shared and stored by the service provider. For example, once the user shares their INSTAGRAM® data with AMAZON®, the user is unable to erase their user data from AMAZON®.

Fourth, there is substantial variance in available user data and the manner in which the user data is stored because each online entity may generate different types of user data. For example, INSTAGRAM® may generate user data related a user's engagement with their posts while a newspaper having a website, such as THE NEW YORK TIMES®, may generate user data related to which articles a user accessed. In such an example, INSTAGRAM® may have a first schema for storing their user data (e.g., a database schema) and THE NEW YORK TIMES® may have a second schema for storing their user data. To obtain the different user data, the service provider undertakes building a different data retrieval system for each online entity. For example, AMAZON® must build a data retrieval system for INSTAGRAM® and a different data retrieval system for THE NEW YORK TIMES®. Building a data retrieval system customized to each online entity, which may include custom software, custom database management, etc., is either technologically impractical or substantially cumbersome and costly (e.g., computationally costly). For example, a substantial number of service provider technological personnel may be needed to build each data retrieval system and a corresponding number of hardware computational resources (e.g., processing power, memory, network bandwidth) is needed to effectuate operation of these systems.

Fifth, the service providers typically are unable to transform obtained user data into a useful result. Each online entity may generate different types of user data and store it differently. To generate useful results, the service provider needs to understand what type of user data they have obtained; identify what insights may be gleaned from the types of user data; and determine how the insights can be applied to the specific products and/or services that the service provider offers. Service providers may be overwhelmed with the enormous amount of user data and different types thereof such that the service providers either do not provide useful recommendations to a user based on their user data or do not make use of the user data at all and, instead, store the user data for some later purpose without providing a useful result to the user in exchange for their user data.

The inventors have developed a new personalization service to overcome these problems with conventional data sharing techniques. The personalization service enables a service provider to request the transformation of a user's data into a useful result. Additionally or alternatively, the personalization service enables a service provider to request the transformation using any other data the service provider provides in the request. For example, the personalization service may enable a service provider to request the transformation of the user's data and/or any other data the service provider provides in the request for transformation. The service provider may present the result to a user to improve the user's interaction with the service provider.

The personalization service, with the user's authorization, may access and/or maintain a user's data in accordance with the data privacy considerations of the user. The user may instruct the personalization service with whom and to what portion(s) of their data may be shared. The personalization service may request user data from one or more data sources having data of the user. The personalization service may process and store the requested user data in accordance with a database schema.

The personalization service may receive, from a service provider, a request for a data product personalized to the user. The request may include information identifying or that can be used to identify at least one data source storing user data for the user and that the user has authorized the data product personalization service to access and (ii) information indicating how to transform at least some of the user data to generate the data product personalized to the user. Additionally or alternatively, the request may include information provided by the service provider to be used in the request. Examples of such data provided by the service provider include data, information, image(s), video(s), and identifier(s).

A “data product” personalized to a user may refer to or be inferred from any data or information generated using at least some of the user's data. Examples of applications in which data products may be generated include search engine results, ranked lists of recommendations, and chat applications (e.g., chatbots) personalized to a user. Examples of data products include audio data, image data, text data (e.g., data representative of natural language text), video data, and indication(s) thereof. For example, a data product can be an advertisement implemented by media (e.g., audio, image, text, and/or video) and personalized to the user. In another example, a data product can be a recommendation, which may include an image of shoes sold by AMAZON®, a description of the shoes, and/or an Internet uniform resource locator (URL) for the shoes on AMAZON®. In such an example, AMAZON® may provide a list of candidate shoes, to the personalization service, and request that the list be ranked (e.g., reranked) in order of a user's likelihood to purchase according to the user's preference indicated by the user data. Furthering this example, the data product may include an identification of the shoes in the list of candidate shoes. By way of another example, a data product can be a combination of different types of data. For example, a data product can be and/or include an augmented reality image of a user wearing the shoes sold by AMAZON®, the description of the shoes, and/or the URL (and/or other identifier) for the shoes on AMAZON®.

The personalization service may obtain, using the information identifying or that can be used to identify the at least one data source, the at least some of the user data from, or previously retrieved from, the at least one data source. The personalization service may generate, using the information indicating how to transform the at least some of the user data and a data transformation service, the data product personalized to the user. The personalization service may provide, to the service provider and via the at least one communication network, the generated data product personalized to the user.

By way of example, a user may visit the website of AMAZON®. The personalization service may receive, from AMAZON®, a request for a data product personalized to the user. The request may include information identifying or that can be used to identify a list of candidate products, such as shoes, available for sale on AMAZON®. The request may include information identifying or that can be used to identify INSTAGRAM®. In this example, INSTAGRAM® stores user data for the user and the user has authorized the personalization service to access the user data from INSTAGRAM®. The request may include information indicating how to transform at least some of the user data from INSTAGRAM® to generate a recommendation of which shoes on AMAZON® to present to the user for purchase. The recommendation for shoes may be a data product personalized to the user because the recommendation may be generated at least in part on the user's data from INSTAGRAM®.

Continuing the example, the personalization service may obtain, using the information identifying or that can be used to identify INSTAGRAM®, at least some of the user's INSTAGRAM® data. The personalization service may have previously stored the at least some of the user's INSTAGRAM® data in at least one datastore such that the personalization service may obtain the at least some of the user's INSTAGRAM® data from the at least one datastore. Additionally or alternatively, the personalization service may obtain the at least some of the user's INSTAGRAM® data from INSTAGRAM® responsive to the request from AMAZON®.

Furthering the example, the personalization service may generate, using the information indicating how to transform the at least some of the user data from INSTAGRAM® and a data transformation service, the shoe recommendation personalized to the user. The personalization service may generate, using the list of candidate shoes from AMAZON®, a ranked list of the candidate shoes in the order in which the user may be likely to purchase in accordance with their preferences as indicated by their INSTAGRAM® data. For example, the data transformation service may include execution of a machine learning model, such as a large language model (LLM). In such an example, the information indicating how to transform the at least some of the user data may be a prompt to the LLM. The prompt may include text-based instructions to direct the LLM to generate a recommendation for shoes sold by AMAZON® using the at least some of the user data from INSTAGRAM®. The LLM may output the recommendation for shoes to the personalization service. The personalization service may provide to AMAZON® the recommendation for shoes, which is personalized to the user.

Beneficially, the technology can perform any transformation of any type and/or quantity of user data into a data product without relinquishing control of the user's data over to a requesting service provider. In this way, the technology effectuates data privacy of a user at a privacy level specified by the user while enhancing the interactions between the user and the service providers to which they engage.

The technology overcomes the problems faced by users and service providers with conventional data sharing techniques. The technology enables a user to maintain control over their user data while receiving, from a service provider, useful results such as optimized product and/or service recommendations that align with their past behavior (e.g., online behavior, offline behavior such as data from a wearable device) and as indicated by their user data. The technology enables a service provider to deliver a personalized experience to a user without consuming hardware computational resources (e.g., processing power, memory, network bandwidth) by executing multiple data retrieval systems and storing user data at scale. For example, the technology enables a service provider to specify the parameters of an online experience to provide to a user and the type(s) and/or source(s) of data that is/are useful to deliver the online experience without requiring custody of the user's data.

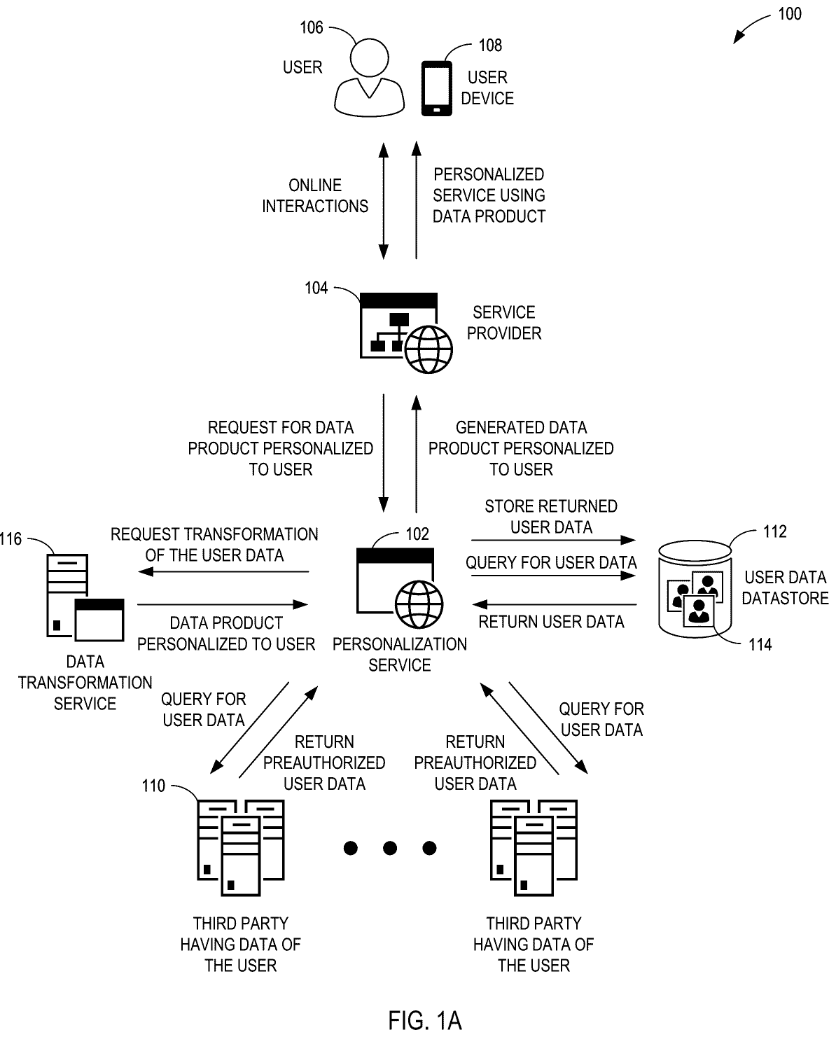

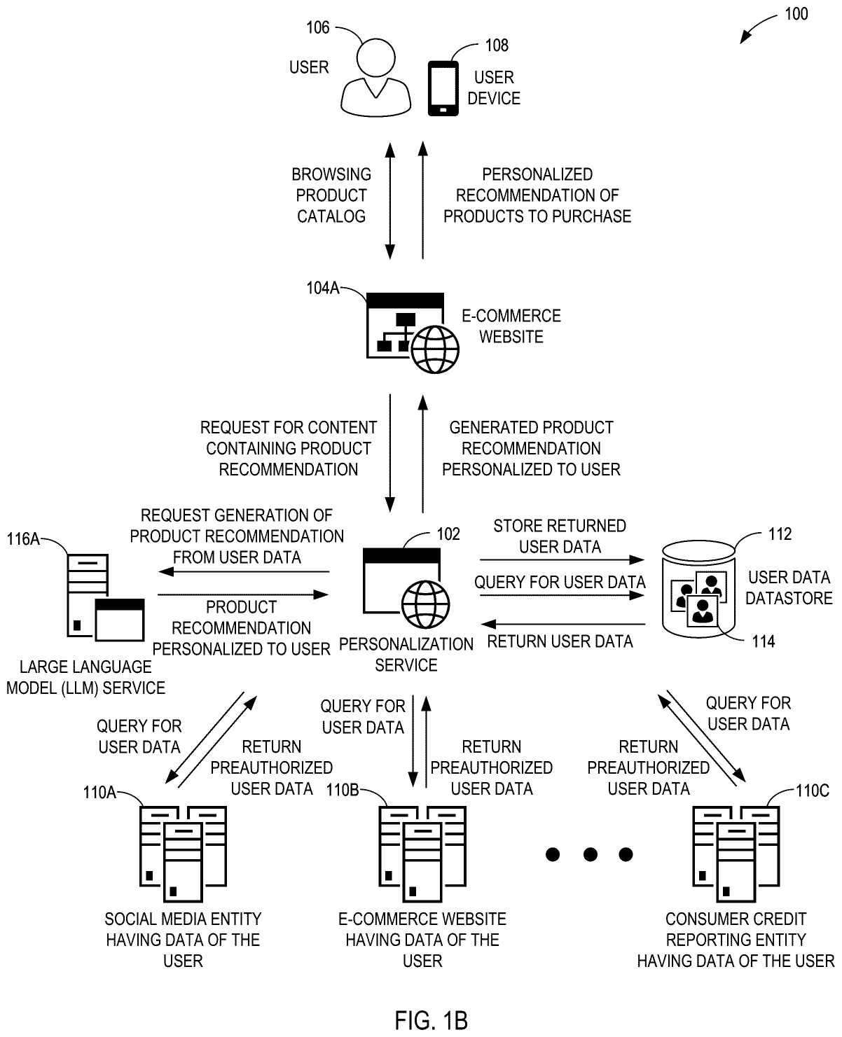

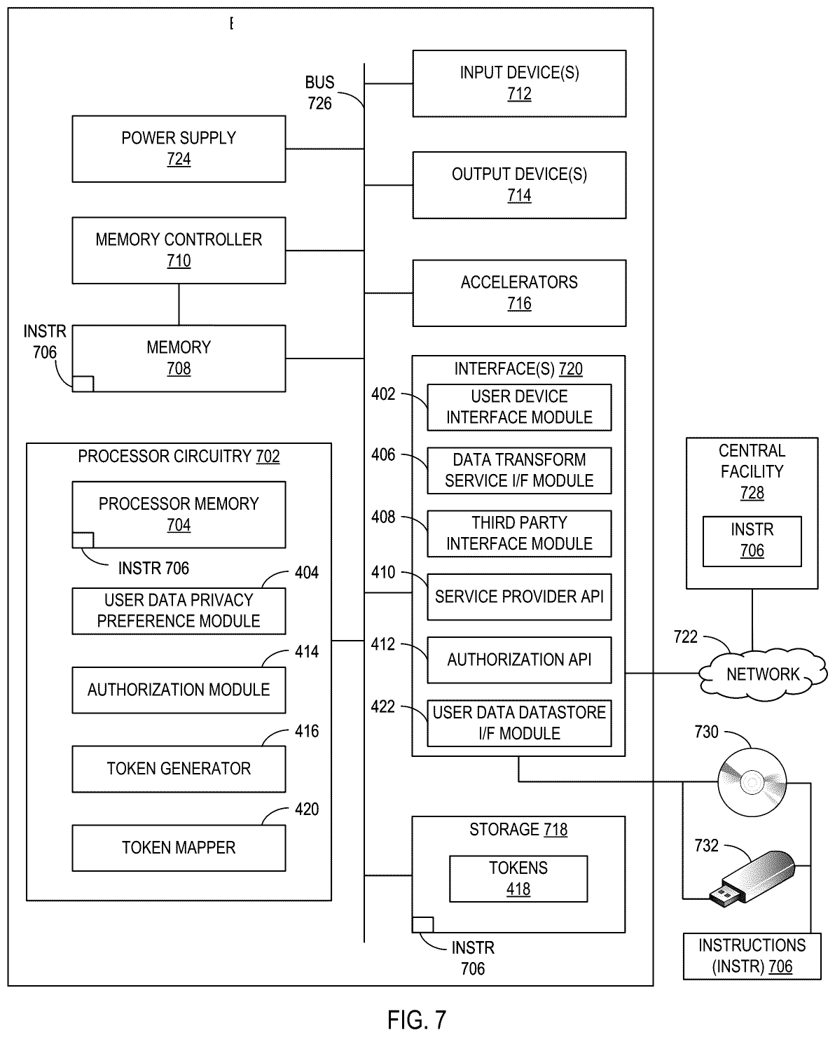

Accordingly, some embodiments provide for a system (e.g., the system of FIGS. 1A and/or 1B) for generating, by a data product personalization service (e.g., the data product personalization service of FIGS. 1A, 1B, 2, 3, 4A, 4B, and/or 4C) and for a service provider (e.g., the service provider of FIGS. 1A, 1B, 3, 4A, 4B, and/or 4C), a data product personalized to a user (e.g., the user of FIGS. 1A, 1B, 3, 4A, 4B, and/or 4C) with whom the service provider is to interact, the system comprising: at least one hardware processor (e.g., the processor circuitry of FIG. 7); and at least one computer-readable storage medium (e.g., the memory, the processor memory, and/or the storage of FIG. 7) storing processor-executable instructions (e.g., the instructions of FIG. 7) that, when executed by the at least one hardware processor, cause the at least one hardware processor to perform a method comprising: (A) receiving, from the service provider and via at least one communication network, a request for the data product personalized to the user, the request comprising: (i) information identifying or that can be used to identify at least one data source (e.g., at least one of the third parties of FIGS. 1A and/or 1B) storing user data (e.g., user data for the plurality of users of FIGS. 1A and/or 1B) for the user that the user has authorized the data product personalization service to access; and (ii) information indicating how to transform at least some of the user data to generate the data product personalized to the user; (B) obtaining, using the information identifying or that can be used to identify the at least one data source, the at least some of the user data from, or previously retrieved from, the at least one data source; (C) generating, using the information indicating how to transform the at least some of the user data and a data transformation service (e.g., the data transformation service of FIG. 1A, the LLM service of FIG. 1B), the data product personalized to the user; and (D) providing, to the service provider and via the at least one communication network, the generated data product personalized to the user.

In some embodiments, the data transformation service comprises a generative machine learning (ML) model, and generating the data product personalized to the user comprises: causing the data transformation service to process the at least some of the user data with the generative ML model based on the information indicating how to transform the at least some of the user data.

In some embodiments, the data transformation service comprises a generative machine learning (ML) model, and generating the data product personalized to the user comprises: generating ML input using the at least some of the user data and the information indicating how to transform the at least some of the user data; providing the ML input to the data transformation service for processing by the generative ML model to obtain a respective output; and receiving the respective output from the data transformation service.

In some embodiments, the generative machine learning model is a large language model (LLM).

In some embodiments, generating the ML input comprises generating a prompt for the LLM using the at least some of the user data and the information indicating how to transform the at least some of the user data.

In some embodiments, the processor-executable instructions further cause the at least one hardware processor to perform providing the respective output from the data transformation service to the service provider as the generated data product personalized to the user.

In some embodiments, the processor-executable instructions further cause the at least one hardware processor to perform: receiving, from the user via at the at least one communication network, authorization for the data product personalization service to obtain the at least some of the user data from the at least one data source; obtaining the at least some of the user data from the at least one data source via the at least one communication network; and storing the at least some of the user data in at least one datastore (e.g., the at least one datastore of FIGS. 1A, 1B, 2, 4A, 4B, and 4C.

In some embodiments, storing the at least some of the user data in the at least one datastore comprises storing the at least some of the user data in the at least one datastore such that the at least one datastore is only accessible by the data product personalization service.

In some embodiments, storing the at least some of the user data in the at least one datastore comprises storing the at least some of the user data in the at least one datastore in accordance with a database schema comprising data fields representing categories of information in the user data.

In some embodiments, the at least one data source comprises one or more first data sources (e.g., one or more first ones of the third parties 110 of FIG. 1A) and one or more second data sources (e.g., one or more second ones of the third parties 110 of FIG. 1A), and receiving authorization for the data product personalization service comprises receiving authorization for the data product personalization service to obtain the at least some of the user data from the one or more first data sources.

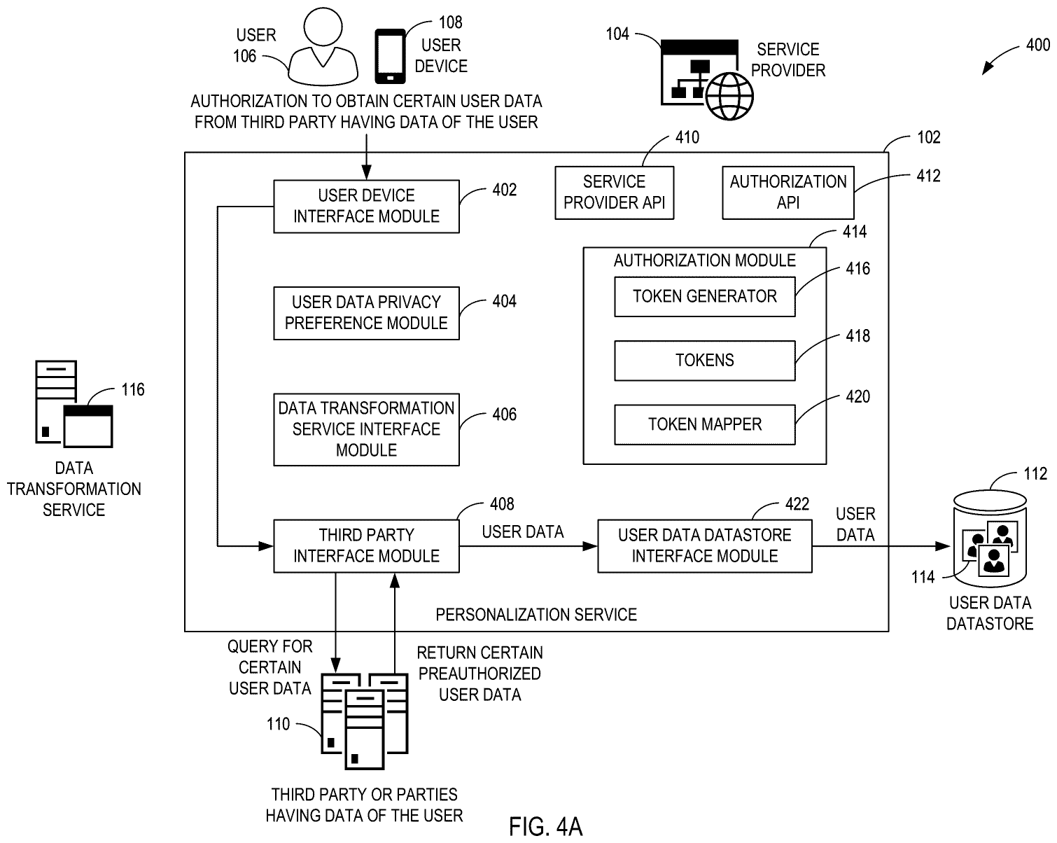

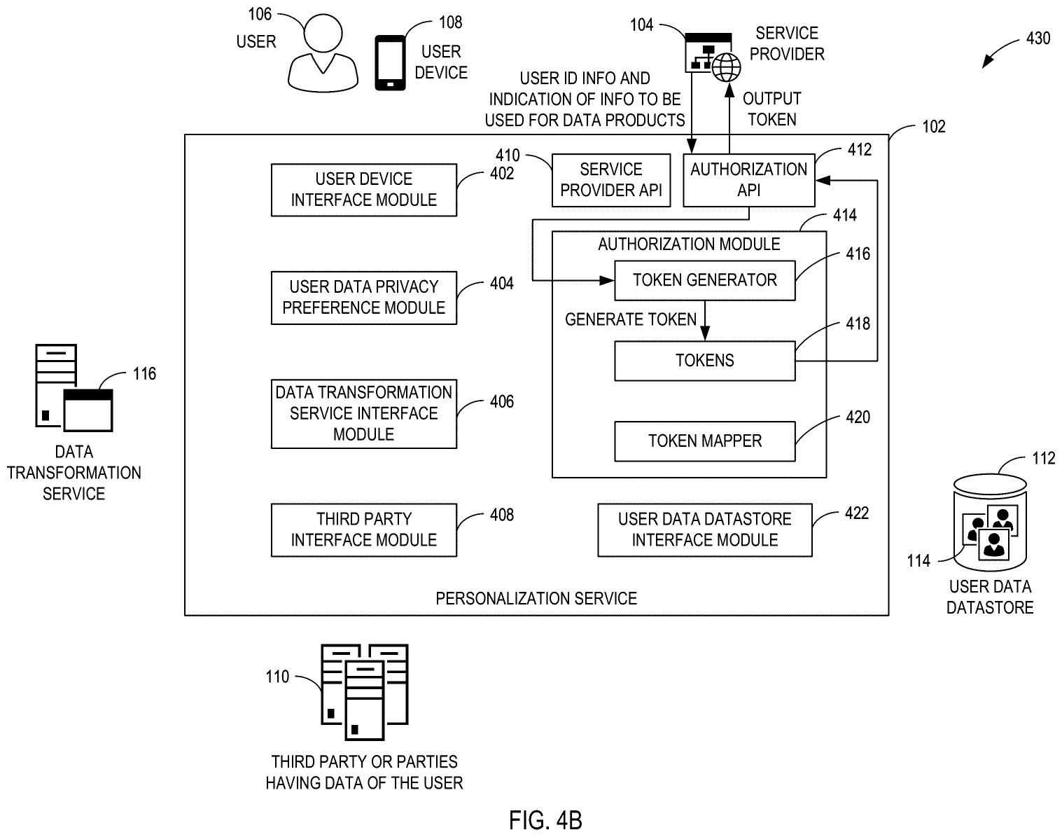

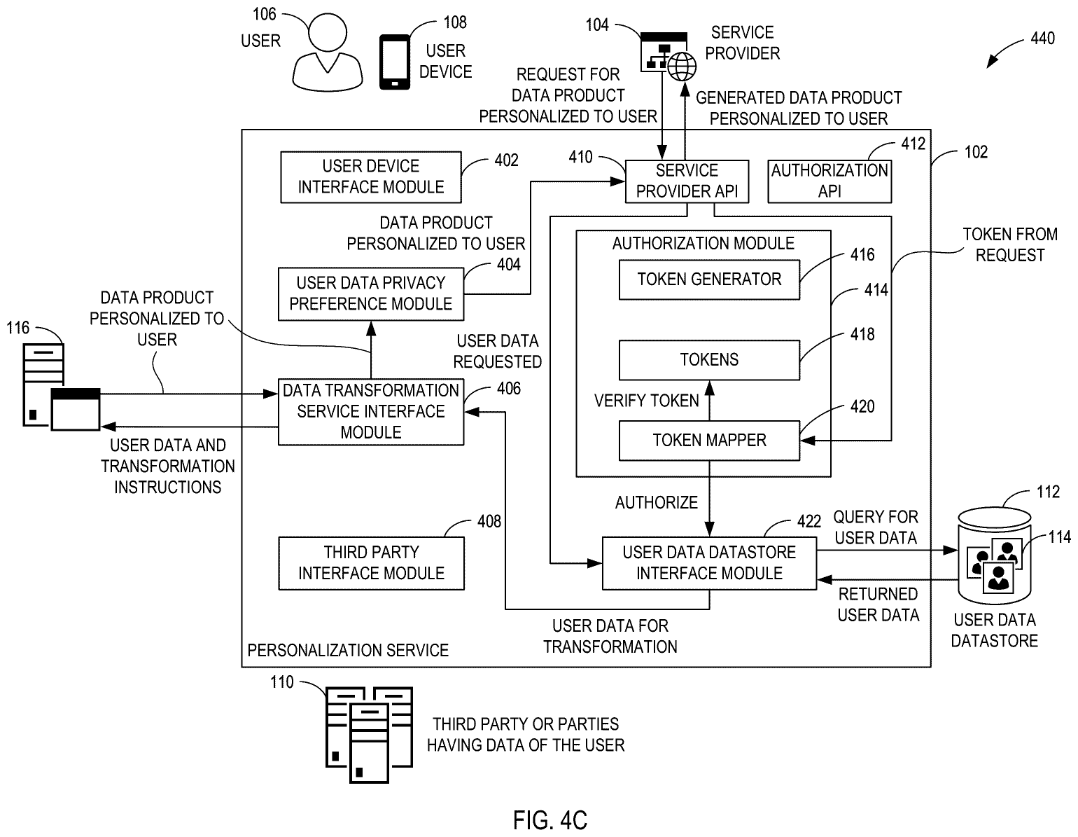

In some embodiments, the processor-executable instructions further cause the at least one hardware processor to perform: receiving, from the service provider and via the at least one communication network, information identifying the user; generating authorization data (e.g., the tokens 418 of FIGS. 4A, 4B, 4C, and 7) to represent a data association of the information identifying the user; and providing the authorization data to the service provider for generation of the request for the data product personalized to the user.

The techniques described herein may be implemented in any of numerous ways, as the techniques are not limited to any particular manner of implementation. Examples of details of implementation are provided herein solely for illustrative purposes. Furthermore, the techniques disclosed herein may be used individually or in any suitable combination, as aspects of the technology described herein are not limited to the use of any particular technique or combination of techniques.

Turning to the figures, the illustrated example of FIG. 1A is a system 100 for generating, by a personalization service 102 and for a service provider 104, a data product personalized to a user 106 with whom the service provider 104 is to interact. The system 100 of FIG. 1A, is a data product generation system, which can generate data products personalized to a user, such as the user 106, responsive to requests from the service provider 104 for the data products.

The user 106 of the illustrated example is a human user (i.e., a human person). Alternatively, the user 106 may be a machine user (e.g., a computer server). The user 106 in this example has a user device 108 that the user 106 utilizes to engage and/or interact with online entities, such as the service provider 104. The user device 108 of this example is a mobile device, such as an Internet-enabled cellular phone (e.g., a smartphone). Alternatively, the user device 108 may be any other type of electronic device. Examples of electronic devices include laptop computers, tablet computers, televisions (e.g., smart televisions), set-top boxes, streaming devices, and wearable devices (e.g., headphones, headsets (e.g., augmented reality and/or virtual reality (AR/VR) headsets, smartwatches, smart glasses (e.g., AR/VR smart glasses), etc.). Although the example of FIG. 1A depicts only a single user and a single user device, any other number of users and/or user devices is contemplated. For example, the example of FIG. 1A may include a plurality of users that engage the service provider 104 to create and/or provide a personalized experience to one(s) of the plurality of users using their own respective user data and/or the user data among the plurality of users.

In the illustrated example, the user 106, via the user device 108, has online interactions with the service provider 104. The service provider 104 of this example is an online entity or a collection of online entities presented to the user 106 via an interface, such as an Internet browser or a mobile operating system software application. Additionally or alternatively, the service provider 104 may be accessed using any other type of interface, such as an application programming interface (API).

In some embodiments, the service provider 104 is implemented by one or more servers (e.g., computer servers) accessible via a network (e.g., a computer-implemented network). For example, the service provider 104 can be implemented by one or more physical servers and/or virtualizations of the one or more physical servers. In some embodiments, the one or more servers are hosted by a cloud provider (e.g., a public cloud provider, a private cloud provider) and/or an enterprise network.

Examples of the service provider 104 include information service entities, Internet websites, mobile device software applications, advertising technology entities, and streaming media services. Examples of information service entities include data and market measurement firms (e.g., audience measurement entities), data brokers, entities that provide electronic newsletters, and financial advice entities (e.g., entities that provide advice, recommendation, or suggestions related to financial instruments such as bonds, mutual funds, options, and stocks). Examples of Internet websites include e-commerce websites, online news websites, and productivity websites (e.g., cloud-based word processing, spreadsheet editing, and presentation creation software). Examples of mobile device software applications include e-commerce applications (e.g., shopping-oriented applications, travel fare aggregators or metasearch engines), finance applications (e.g., mobile banking, brokerage services, credit monitoring services), social media networks, and collaboration tools (e.g., instant messaging, video conferencing). Examples of advertising technology entities include marketing automation technology entities (e.g., technologies, products, and services designed to personalize digital content delivery to users), demand-side platforms (e.g., software to automate the management and purchasing of advertisement inventory), and supply-side platforms (e.g., software to automate the management, selling, and optimization of advertisement inventory). Examples of streaming media services include applications for Internet-based streaming of audio books, movies, music, podcasts, and/or television shows.

The service provider 104 of the illustrated example is separate from the personalization service 102 such that they are different entities to implement data privacy for the user 106. For example, hardware and software of the service provider 104 is different from hardware and software of the personalization service 102. In such an example, data stored and/or managed by the service provider 104 is different from data stored and/or managed by the personalization service 102. With such a separation between the service provider 104 and the personalization service 102, user data in its entirety and/or original form may not be shared with the personalization service 102 is not shared with the service provider 104. For example, the personalization service 102 may output a portion of the user's data, such as an instance of a product being purchased or event details from the user's calendar but may not output all the user's shopping history or the user's entire calendar. Due to the separation, the personalization service 102 can control user data access by the service provider 104. For example, the personalization service 102 may provide data products personalized to the user 106 to the service provider 104 without providing the service provider 104 access to any of the user data used to generate the data products. In another example, the personalization service 102 may provide data products personalized to the user 106 to the service provider 104 by providing, to the service provider 104, access (and as authorized by the user 106) to a minimal and/or otherwise reduced quantity of user data for generation and/or output of the data products. Beneficially, the user 106 can authorize the service provider 104 to request data products personalized to the user 106 without releasing control and/or custody of the user's data to the service provider 104. Alternatively, at least part of the personalization service 102 may be integrated and/or incorporated into the service provider 104 while maintaining data privacy for the user 106. For example, software corresponding to at least some function(s) of the personalization service 102 can be included in the service provider 104 but user data managed and/or stored by the personalization service 102 is not accessible by the service provider 104.

Furthering the illustrated example of FIG. 1A, the user 106 can interact with the service provider 104, such as by browsing a good, a product, etc., of a catalog offered by the service provider 104 and/or reviewing services offered by the service provider 104. The service provider 104 can request the personalization service 102 for data product(s) personalized to the user 106. For example, the requested data product(s) can be and/or include a product and/or service recommendation offered by the service provider 104, information (e.g., information article(s), financial advice or suggestion(s), audio and/or video content) that may be of interest to the user 106, and/or any combination(s) thereof.

The personalization service 102 of the illustrated example is a data product personalization service. In some embodiments, the personalization service 102 is implemented by one or more servers (e.g., computer servers) accessible via a network (e.g., a computer-implemented network). For example, the personalization service 102 can be implemented by one or more physical servers and/or virtualizations of the one or more physical servers. In some embodiments, the one or more servers are hosted by a cloud provider (e.g., a public cloud provider, a private cloud provider) and/or an enterprise network.

To effectuate the request from the service provider 104, the personalization service 102 determines whether the service provider 104 is authorized to receive the requested data products personalized to the user 106. For example, the user 106 can login to the personalization service 102 via the service provider 104 to indicate to the personalization service 102 that the service provider 104 is authorized to request personalized data products.

After determining that the service provider 104 is authorized by the user 106, the personalization service 102 inspects the request from the service provider 104 to determine how to generate the data product. For example, the personalization service 102 can identify, from the request, identifications of certain portion(s) of user data for the user 106 and certain third parties 110 having the data from which the data product is to be generated and/or transformed. Additionally or alternatively, the personalization service 102 may identify, from the request, information from the service provider 104 to effectuate at least part of the transformation. For example, the personalization service 102 may identify, from the request, a list of candidate products from the service provider 104. In such an example, the personalization service 102 may determine that the request is for the personalization service 102 to rank the products in the provided list in accordance with (i) provided instructions from the service provider 104 for transformation and (ii) identifications of certain portion(s) of user data for the user 106 and certain third parties 110 having the user data from which the data product is to be generated and/or transformed.

The illustrated example of FIG. 1A depicts a plurality of the third parties 110. The third parties 110 can be online entities as described above, or other entities accessible via a network. Examples of these other entities include information product companies (e.g., data brokers) that specialize in collecting user data either from public records or sourced privately and data and market measurement firms (e.g., audience measurement entities). In the shown example, the third parties 110 are respectively implemented by one or more computer servers and/or corresponding software to effectuate the exchange of user data with the personalization service 102.

The system 100 of the depicted example can be implemented at least in part by one or more networks. For example, the user 106, via the user device 108, can interact with the service provider 104 using one or more networks. In another example, the personalization service 102 can query the third parties 110 for user data using one or more networks. One or more of these networks may be implemented by any wired and/or wireless network(s) such as one or more cellular networks (e.g., 4G LTE cellular networks, 5G cellular networks, future generation 6G cellular networks, etc.), one or more data buses, one or more local area networks (LANs), one or more optical fiber networks, one or more private networks, one or more public networks, one or more satellite networks, one or more wireless local area networks (WLANs), etc., and/or any combination(s) thereof. For example, one or more networks that may be used in connection with the system 100 may be the Internet, but any other type of private and/or public network is contemplated.

In some embodiments, the personalization service 102 can fulfill the data product requests from the service provider 104 by using prefetched user data and/or dynamically fetched user data. For example, prior to receiving the requests from the service provider 104, the personalization service 102 can receive authorization from the user 106 to access certain portion(s) of the user's data from one or more of the third parties 110 having the user's data. In such an example, the personalization service 102 can query the one or more of the third parties 110 for the certain portion(s) of the user's data. In response to the query, the third parties 110 can return the requested data, which is shown in this example as the third parties 110 returning preauthorized user data to the personalization service 102. However, the example of FIG. 1A is not so limited. Additionally or alternatively to prefetching user data, in response to receiving a data product request from the service provider 104, the personalization service 102 may query the certain one(s) of the third parties 110 for the certain portion(s) of the user's data.

In the illustrated example, the personalization service 102 stores the returned user data in at least one datastore 112. The at least one datastore 112 of this example is a user data datastore, which can include user data for a plurality of users 114. In some embodiments, the at least one datastore 112 can be implemented by any technology for storing data. For example, the at least one datastore 112 can be implemented by a volatile memory (e.g., a Synchronous Dynamic Random Access Memory (SDRAM), a Dynamic Random Access Memory (DRAM), a RAMBUS Dynamic Random Access Memory (RDRAM), etc.) and/or a non-volatile memory (e.g., flash memory). The at least one datastore 112 may additionally or alternatively be implemented by one or more double data rate (DDR) memories, such as DDR, DDR2, DDR3, DDR4, mobile DDR (mDDR), etc. The at least one datastore 112 may additionally or alternatively be implemented by one or more mass storage devices such as hard disk drive(s) (HDD(s)), compact disk (CD) drive(s), digital versatile disk (DVD) drive(s), solid-state disk (SSD) drive(s), etc. While in the illustrated example the at least one datastore 112 is illustrated as a single datastore, the at least one datastore 112 may be implemented by any number and/or type(s) of datastores. Furthermore, the data stored in the at least one datastore 112 may be in any data format. Examples of data formats include a flat file, binary data, comma delimited data, tab delimited data, and structured query language (SQL) structures.

In some embodiments, the at least one datastore 112 may be implemented by a database system, such as one or more databases. The term “database” as used herein means an organized body of related data, regardless of the manner in which the data or the organized body thereof is represented. For example, the organized body of related data may be in the form of one or more of a table, a log, a map, a grid, a packet, a datagram, a frame, a file, an e-mail, a message, a document, a report, a list or in any other form. In some embodiments, the at least one datastore 112 may be implemented by a database system in accordance with a database schema. For example, the database system can be arranged, organized, and/or otherwise structured to sort and store user data in a unified and/or standardized manner. In such an example, the database system implemented by the at least one datastore 112 can store different types of user data from different one(s) of the third parties 110 using the same database schema to effectuate efficient querying and returning of pertinent user data for data product transformation operations.

By way of example, the database system can create an instance of the database schema (e.g., a database schema instance) for each user. The instance of the database schema can include a plurality of data fields and/or any other types of database structures. The database system can store user data from a first one of the third parties 110 into first one(s) of the plurality of data fields to which the user data is applicable. The database system can store user data from a second one of the third parties 110 into one or more of the first one(s) and/or second one(s) of the plurality of data fields to which the user data is applicable. For example, if the first and second ones of the third parties 110 store travel related user data for the user, such user data can be stored using the same data fields of the database schema instance related to travel. In another example, if the first one of the third parties 110 stores shopping related user data for the user and the second one of the third parties 110 stores calendar event user data for the user, such user data can be stored using different data fields of the database schema instance.

In the illustrated example of FIG. 1A, the personalization service 102 can query the at least one datastore 112 for user data indicated in the data product requests from the service provider 104. For example, the service provider 104 can request the personalization service 102 for a data product personalized to travel interests of the user 106. In such an example, the service provider 104 can include as at least part of the request identifications of portion(s) of the user's data associated with travel. Furthering the example, such identified portion(s) of the user data can include the user's previously visited locations (e.g., towns, cities, countries), previous airfare and/or lodging purchases by the user 106, and/or the user's engagements with travel associated social media content. Responsive to such a request for travel-related user data, the personalization service 102 can query the at least one datastore 112 for such stored data for the user 106.

In response to obtaining the user data from the at least one datastore 112, the personalization service 102 can transform at least some of the obtained user data into the requested data product. For example, the personalization service 102 can provide the at least some of the returned user data (e.g., prefetched user data from the at least one datastore 112 and/or dynamically fetched user data from one(s) of the third parties 110) as data inputs to a data transformation service 116. Additionally, the personalization service 102 can provide information, such as transformation information, indicating how to transform the at least some of the user data to generate the data product personalized to the user 106 as data inputs to the data transformation service 116. Examples of the information include calls (e.g., API calls), messages (e.g., database commands), and alphanumeric text based instructions.

In the shown example, the data transformation service 116 is separate from and/or external to the personalization service 102. For example, the personalization service 102 and the data transformation service 116 can be provided by and/or managed by different entities. In such an example, the personalization service 102 can be implemented by one or more computer servers associated with one entity and the data transformation service 116 can be implemented by one or more computer servers associated with one or more different entities. Alternatively, at least part of the data transformation service 116 may be included in and/or implemented by the personalization service 102. For example, the personalization service 102 and the data transformation service 116 can be provided by and/or managed by the same entity. In such an example, the personalization service 102 can execute an instance of the data transformation service 116 using a combination of hardware, software, and firmware of and/or associated with the personalization service 102.

In the depicted example, the data transformation service 116 can generate the data product personalized to the user 106 as data output(s) by transforming the at least some of the user data in accordance with the transformation information. The data transformation service 116 can output the data product to the personalization service 102. In some embodiments, the personalization service 102 can adjust, alter, modify, and/or otherwise change the data product in accordance with data privacy preferences of the user 106. For example, the personalization service 102 can remove sensitive financial information from the data product in accordance with a data privacy preference of the user 106 that sensitive financial information is not to be shared with the service provider 104 (and/or any other service provider). Alternatively, the user 106 may not have data privacy preferences such that the personalization service 102 may output the data product to the service provider 104 without changes.

In the illustrated example, the service provider 104 receives the generated data product personalized to the user 106. For example, the service provider 104 can display and/or present the generated data product to the user 106 via a graphical user interface (GUI) implemented and/or hosted by the service provider 104. In such an example, the GUI can be part of an Internet browser or another type of web interface (e.g., a pop-out GUI). In some embodiments, the GUI can be a chatbot interface. Additionally or alternatively, the service provider 104 may output the data product to the user 106 in a different format, such as by transmitting the data product to the user 106 in electronic mail (i.e., e-mail) and/or text messaging.

By way of another example, the personalization service 102 can generate data products personalized to an objective rather than to particular user(s) based on their user data. In such an example, assume that the service provider 104 is an information provider, such as a financial services entity that provides advice, recommendations, or suggestions related to financial instruments (e.g., bonds, mutual funds, options, and stocks). In such an example, the information provider intends to provide a data product personalized to an objective, such as providing stock purchasing suggestions to subscribers and/or users of the information provider. The subscribers/users may or may not be associated with the personalization service 102 (e.g., the users may or may not have accounts with the personalization service 102).

One technique for effectuating this objective includes the information provider requesting the personalization service 102 for a data product personalized to the objective of generating stock purchase recommendations and using certain information from certain third parties. In this example, the certain third parties may also be information sources, such as Internet-accessible blogs, newspapers, magazines, and/or message boards. In this example, the certain information may be financial information related to publicly traded companies. Responsive to the request, the personalization service 102 can query the at least one datastore 112 for the certain information from the certain third parties. Additionally or alternatively, the personalization service 102 can query one(s) of the third parties 110 in response to receiving the request from the information provider. The personalization service 102 can provide the request for the transformation of the certain data from the certain third parties to the data transformation service 116 to cause the data transformation service 116 to generate the data product personalized to the objective of generating stock purchase recommendations. The personalization service 102 can return the data product to the information provider, who, in turn, can provide content including the data product to its subscribers/users.

Another technique for effectuating this objective includes the information provider requesting the personalization service 102 for a data product personalized to the user 106 and using a user's license(s) and/or subscription(s) to information for generation of the data product. For example, the information provider may request the personalization service 102 to use available license(s) and/or subscription(s) of the user 106 to access information related to publicly traded companies for generation of stock purchase recommendations to the user 106. In such an example, the user 106 may be a customer, a licensee, and/or a subscriber of the information provider. The information provider may identify the license(s)/subscription(s) to use while in other examples the personalization service 102 may identify the license(s)/subscription(s) for use. For example, the personalization service 102 may identify one or more licenses and/or subscriptions that the user 106 maintains and that the user 106 has authorized the personalization service 102 to access and/or use in compliance with the license and/or subscription terms. Furthering the example, the personalization service 102 and/or the information provider may determine that the user 106 has a subscription to a newspaper (e.g., one of the third parties 110) that publishes their articles online for digital and/or Internet access. The personalization service 102 may query the newspaper, via one or more computer-implemented networks and using the subscription of the user 106, for articles including and/or corresponding to financial information related to publicly traded companies. The personalization service 102 can provide the request for the transformation of financial information from the newspaper to the data transformation service 116 to cause the data transformation service 116 to generate the data product of stock purchase recommendations personalized to the user 106 and information available to the user 106, such as information accessible via license(s)/subscription(s) of the user 106. The personalization service 102 can return the data product to the information provider, who, in turn, can provide content including the data product to the user 106.

FIG. 1B is an example implementation of the system 100 of FIG. 1A for generating a data product requested by an example of the service provider 104 of FIG. 1A. In the illustrated example, the service provider 104 of FIG. 1A is represented as an e-commerce website 104A in FIG. 1B. For example, the e-commerce website 104A can be a provider of products and/or services for purchase by the user 106. However, the description in connection with FIG. 1B is not so limited and may be applicable to any other type of online entity, such as an online news website, streaming media service, or the like.

In the example of FIG. 1B, the user 106 can authorize the personalization service 102 to query for user data from one(s) of the third parties 110A, 110B, 110C having data of the user 106. The third parties 110A, 110B, 110C shown in FIG. 1B include a social media entity 110A (e.g., a social media network), an e-commerce website 110B different from the e-commerce website 104A, and a consumer credit reporting entity 110C. The third parties 110A, 110B, 110C may alternatively or additionally include any other number and/or type of third party having data of the user. The personalization service 102 of this example can store returned user data from the authorized one(s) of the third parties 110A, 110B, 110C in the at least one datastore 112 in connection with the user 106, such as storing the returned user data in association with information identifying the user 106 (e.g., a user identifier, personal identifying information (PII)).

The user 106 of the example shown in FIG. 1B can interact with the e-commerce website 104A by browsing, via the user device 108, a product catalog of the service provider 104. For example, the e-commerce website 104A can be a provider of clothing items, such as shoes. In such an example, the user 106 can interact with the e-commerce website 104A by viewing different shoes offered for sale by the e-commerce website 104A in a mobile device application provided by the e-commerce website 104A or in an Internet browser.

To improve the interactions between the user 106 and the service provider 104, such as to persuade the user 106 to purchase shoes from the service provider 104, the service provider 104 may provide data products personalized to the user 106. In this example, the data products can be recommendations of shoes in the service provider's shoe catalog that may align and/or correspond to user data of the user 106. To provide these data products, the e-commerce website 104A may request the personalization service 102 for content containing a shoe product recommendation. For example, the content may include an AR image of the user 106 wearing recommended shoes, an advertisement (e.g., an image advertisement, a video advertisement such as a commercial) that includes recommended shoes, and/or the like. In some embodiments, the e-commerce website 104A may include, as at least part of the request, information of its own such as to improve processing of the request. For example, the e-commerce website 104A may include a list or other sorting of shoes offered for sale by the e-commerce website 104A over which the personalization service 102 is requested to generate a shoe product recommendation.

In response to determining that the user 106 authorized the e-commerce website 104A to make the request, the personalization service 102 may query the at least one datastore 112 for user data of the user 106 in connection with the request. For example, the personalization service 102 may determine, from the request, that the e-commerce website 104A is requesting a data product, such as a type of shoe product recommendation, to be generated based on certain portion(s) of the user's data and from certain one(s) of the third parties 110A, 110B, 110C. In such an example, the personalization service 102 may determine, from the request, that the e-commerce website 104A is requesting what type of shoe to recommend to the user 106 by using shoe-related social media posts from the third parties 110A that the user 106 engaged with and previous purchases of shoes from the e-commerce website 110B. Furthering the example, the personalization service 102 may query the at least one datastore 112 for such data. Additionally or alternatively, the personalization service 102 may determine, from the request, that the e-commerce website 104A is requesting which shoe(s) offered by the e-commerce website 104A to be recommended to the user 106. For example, the personalization service 102 may determine that the request includes a list of shoes that the e-commerce website 104A sells. In such an example, the personalization service 102 may determine, from the request, that the e-commerce website 104A is requesting for the personalization service 102 to rank and/or sort the list of shoes in an order representative of their likelihood to be purchased by the user 106 and in accordance with the data of the user 106.

The personalization service 102 of the example of FIG. 1B causes the generation of data products personalized to the user 106 using one or more ML models. Examples of ML models include generative adversarial networks (GANs) and neural networks (NNs). An example of an NN is a deep neural network. An example of a deep neural network is a large language model (LLM), which is represented in FIG. 1B as an LLM service 116A. Additionally or alternatively, the personalization service 102 may generate data products using any type of non-ML model. Examples of non-ML models include computer-implemented decision trees, Markov Chains, template-based generation models, and context-free grammars (CFGs).

The LLM service 116A of FIG. 1B is configured and/or trained to generate data products in response to an input. For example, the LLM service 116A can be implemented by an LLM trained to understand and, in some instances, generate natural language text as output data products. In some embodiments, the LLM service 116A may generate new combinations of natural language text in the form of natural-sounding language. In some embodiments, the LLM service 116A may generate other types of output such as new audio, images, video, and/or any combination(s) thereof. In some embodiments, the LLM service 116A may be trained to generate text in response to an input textual prompt. For example, the LLM service 116A can be implemented as least in part by a chatbot, such as ChatGPT, that is trained to generate natural language text responsive to text input, which may be a prompt from the personalization service 102. In some embodiments, the LLM service 116A may be configured to generate an image based on an input textual prompt. In some embodiments, the LLM service 116A can be implemented at least in part by a text-to-image model, such as DALL-E, that is trained to generate digital images in response to text input, which may be a prompt from the personalization service 102.

In the example of FIG. 1B, the personalization service 102 may provide at least some of the user's data from the at least one datastore 112 as input to the LLM service 116A. The input to the LLM service 116A may be any type of input, such as audio data, image data, text data, video data, and/or any combination(s) thereof. The personalization service 102 may provide information, which can be extracted from the request, indicating how to transform the at least some of the user's data into a data product personalized for the user 106. For example, the information may include instructions to transform the user's shoe-related social media posts and/or previous purchases of shoes from the e-commerce website 110B into content containing recommendations of shoes for the user 106 to consider purchasing. In such an example, the instructions can include indications of what type(s) of user data and source(s) of the user data (e.g., one(s) of the third parties 110 having data of the user) are to be used to generate the data product. Additionally or alternatively, the instructions can be a prompt to an LLM implemented by the LLM service 116A using any type of data, such as audio, image, text, and/or video data. For example, the prompt to the LLM can include the type(s) of user data from the identified source(s) that, when processed by the LLM, results in the data product personalized to the user 106.

Responsive to receiving the data and the information, the LLM service 116A can generate data output(s) representative of the product recommendation personalized to the user 106. The personalization service 102 can provide the generated product recommendation to the e-commerce website 104A, which, in turn, can provide and/or present the personalized recommendation of shoes to purchase to the user 106.

Beneficially, the personalization service 102 causes generation of data products, such as product recommendations personalized to the user 106 in this example, without providing the e-commerce website 104A access to data of the user 106. Beneficially, the user 106 can maintain control over access to their data while receiving enhanced and/or improved online interactions, such as recommendations for products and/or services customized to the user's interests and previous behavior. Beneficially, the e-commerce website 104A can deliver enhanced user experiences without requiring possession of a user's data and expenditure of human and/or computational resources to build systems to transform the user's data into useful results.

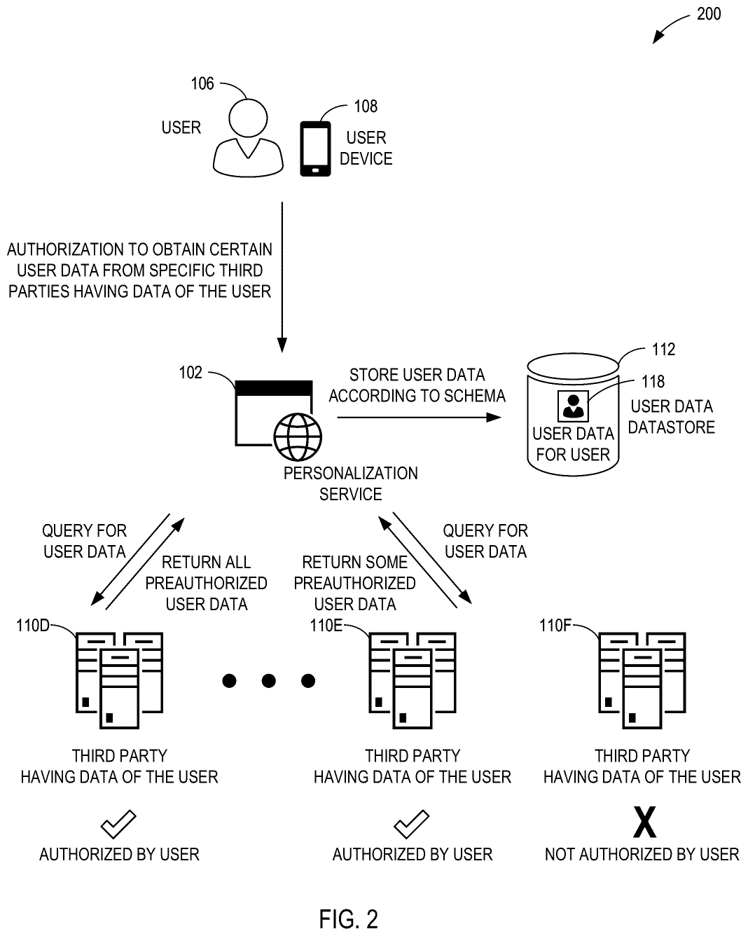

FIG. 2 shows a portion of the system 100 of FIG. 1A to implement an example workflow 200 for retrieving certain user data 118 from specific third parties 110D, 110E, 110F having data of the user 106. In the workflow 200, the personalization service 102 of FIGS. 1A and/or 1B receives an authorization from the user 106 to obtain certain user data from specific third parties having data of the user 106. For example, the user 106 can sign up for an account (e.g., a user account) with the personalization service 102. By signing up, the personalization service 102 can issue the user 106 access credentials (e.g., login credentials), such as user identification information (e.g., a user identifier, a user name) and password (that may be changed by the user 106).

The user 106 of this example can manage the control over their user data via their account with the personalization service 102. For example, the user 106 can identify which one(s) of the third parties 110D, 110E, 110F having data of the user 106 from which the personalization service 102 is authorized to retrieve user data. In some embodiments, the user 106 can provide access credentials to the identified one(s) of the third parties 110D, 110E, 110F and authorize the identified one(s) of the third parties 110D, 110E, 110F to release user data to the personalization service 102. For example, the personalization service 102 may act, operate, and/or serve as an authorized agent on behalf of the user 106 in a data access request. In some embodiments, the user 106 can provide, on a temporary basis, access credentials for the third parties 110D, 110E, 110F such that the personalization service 102 can retrieve user data from the third parties 110D, 110E, 110F on behalf of the user 106.

The personalization service 102 in FIG. 2 can query for user data from identified one(s) of the third parties 110D, 110E, 110F. In the shown example, the user 106 provided authorization for the personalization service 102 to retrieve user data from a first third party 110D and a second third party 110E but not a third third party 110F. Also shown, the user 106 specified which portion(s) of their user data is to be retrieved by the personalization service 102. For example, the user 106 of FIG. 2 provided authorization to the personalization service 102 to retrieve all the user's data from the first third party 110D but only some of the user's data from the second third party 110E.

In response to retrieving the specified user data, the personalization service 102 stores the retrieved user data as stored data 118 for the user 106 in the at least one datastore 112. In the illustrated example, the personalization service 102 stores the user's data 118 according to a schema, such as a database schema. In some embodiments, the schema can represent an arrangement, organization, and/or structure of one or more databases implemented by the at least one datastore 112. For example, the schema can include a plurality of data fields that can be applicable to a variety of user data generated/stored by online entities. In such an example, one(s) of the plurality of data fields can correspond to data of the user 106 and/or one(s) of the plurality of data fields can correspond to data of the online entities. In some embodiments, one or more of the plurality of data fields can represent categories or groupings of information in the user data (e.g., a finance category, a shopping category, a social media category, a travel category). Examples of the plurality of data fields include a user identifier data field to store a unique identifier for a user (e.g., a user identifier), a unique data identifier data field to store a unique identifier for the user data to be stored, an event data field to store a type of the user data (e.g., the user data relates to a purchase, a social media engagement (e.g., a like or reshare), an access of media, purchase history, travel history), a source data field to store an identifier of an online entity where the user data was generated, a timestamp data field to store a timestamp at which the user data was generated, and a properties data field to store all properties relevant and specific to the user data to be stored. Examples of properties include a list of uniform resource locators (URLs) associated with the user data, a user data description (e.g., a summary of industry sector, target audience, main services/products, and unique features or selling propositions in connection with the source of the user data), location data (e.g., geosynchronous positioning system (GPS) data, latitudes and longitudes of the user's location or location in connection with the user data), a type of social media interaction (e.g., an emoji, a like, a repost or reshare), a purchase price for a product and/or service, a currency in which the purchase price was paid, a name of a product/service purchased, and a quantity of a product/service purchased.

Beneficially, by storing user data for the user 106 from each third party having data of the user in accordance with the same schema, the personalization service 102 can efficiently identify and retrieve user data for the user 106 that is pertinent and/or otherwise appropriately relevant to a service provider's request for data products. For example, the personalization service 102 can store travel-related data for the user 106 from the first third party 110D and the second third party 110E in a standardized manner even if the first and second third parties 110D, 110E operate with substantially different contexts from each other (e.g., the first third party 110D is a website for an airline and the second third party 110E is a website for a food-related magazine). Beneficially, by using a schema to standardize the storing of user data from different online entities, a type of user data originating from different third parties can be retrieved from the at least one datastore 112 regardless of how the user data was originally generated and/or stored by the third parties.

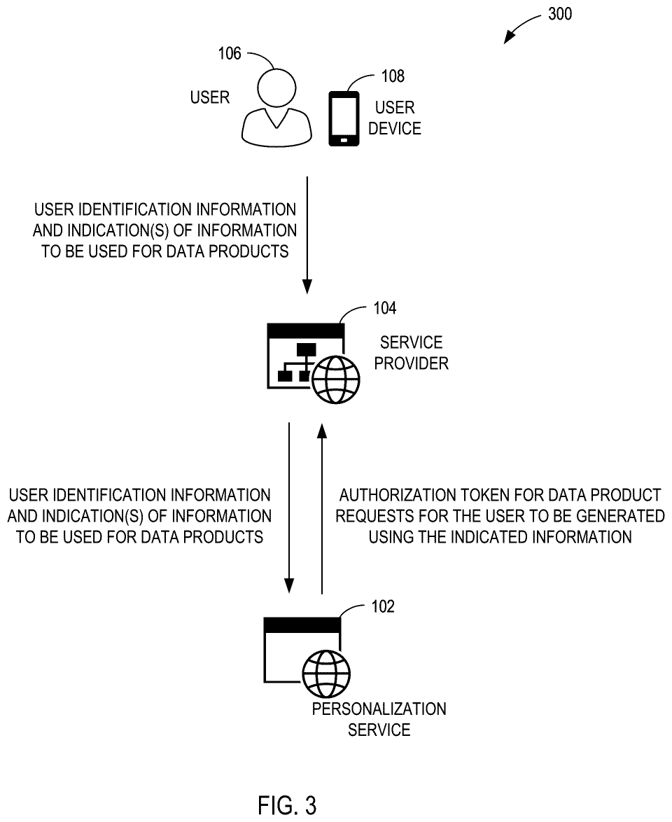

FIG. 3 shows a portion of the system 100 of FIG. 1A to implement an example workflow 300 for authorizing the service provider 104 of FIGS. 1A, 1B, and/or 2 to receive data products personalized to the user 106. In the workflow 300 of FIG. 3, the user 106 provides user identification information and indication(s) of information to be used for generating data products personalized to the user 106. For example, the user identification information can include access credentials of the user 106 for the personalization service 102. In such an example, the service provider 104 can launch a user interface, such as an embedded login GUI, configured to receive access credentials (e.g., a username and/or password) from the user 106 for the personalization service 102. The embedded login may also include requests for indications of information from third parties having data of the user 106 that may be used for data product generation.

The service provider 104 of this example provides the user identification information and indication(s) of information to be used for data products to the personalization service 102. The personalization service 102 can validate the user identification information such as by determining that the access credentials provided by the user 106 match the access credentials for the user 106 maintained by the personalization service 102.

In the illustrated example, the personalization service 102 generates an indicia of user authorization, such as an authorization token, which represents an authorization, by the user 106, for the service provider 104 to request data products personalized to the user 106 and generated using the indicated information. For example, the personalization service 102 can generate the authorization token to represent that the service provider 104 is authorized to request data products that are generated using certain portion(s) of the user's data and from certain third parties as specified by the user 106. In such an example, requests by the service provider 104 for data products using different portion(s) of the user's data and/or from different third parties than previously authorized are rejected to enforce the data privacy preferences of the user 106.

FIG. 4A is a block diagram of an example implementation of the personalization service 102 of at least FIG. 1A for retrieving certain user data from specific third parties having data of the user 106. The implementation of the personalization service 102 shown in FIG. 4A includes a user device interface module 402, a user data privacy preference module 404, a data transformation service interface module 406, a third party interface module 408, a service provider application programming interface (API) 410, an authorization API 412, an authorization module 414, a token generator 416, tokens 418, a token mapper 420, and a user data datastore interface module 422. In the shown example, the authorization module 414 includes and/or implements the token generator 416, the tokens 418, and the token mapper 420.

In example operation, the personalization service 102 of FIG. 4A carries out, performs, and/or executes a workflow 400 for retrieving certain user data from specific third parties having data of the user 106. In example operation, the user device interface module 402 receives authorization from the user 106 (e.g., via the user device 108) for the personalization service 102 to obtain certain user data from at least one third party having data of the user. For example, the user device interface module 402 can be configured to receive data from and/or send data to the user 106. In such an example, the user device interface module 402 can receive changes to user data privacy preferences from the user 106 and/or transmit alerts to the user 106 to inform the user 106 of new or ongoing requests for data products personalized to the user 106.

The user device interface module 402 outputs the authorization, or portion(s) thereof, to the third party interface module 408. The third party interface module 408 is configured to obtain certain user data from certain third parties as authorized by a user, such as the user 106. The third party interface module 408 identifies, from the authorization, one or more third parties having data of the user 106 from which the third party interface module 408 is authorized to request user data. For example, the third party interface module 408 can determine that the user 106 authorized the retrieval of user data from the e-commerce website 110B of FIG. 1B. The third party interface module 408 also identifies, from the authorization, which portion(s) of the user's data is to be retrieved. For example, the third party interface module 408 can determine that only some of the entire collection of user data stored by the e-commerce website 110B can be retrieved.

In example operation, the third party interface module 408 queries the identified one(s) of the third parties 110 for the specified portion(s) of user data. Responsive to the query, the identified one(s) of the third parties 110 return the specified portion(s), which are identified in FIG. 4A as certain preauthorized user data. For example, the returned user data is preauthorized because the user 106 authorized the third party interface module 408 to request the user data before requests for data products have been received. Beneficially, by prefetching user data, the personalization service 102 can generate data products requiring at least some of the prefetched user data with reduced latency because the user data has already been retrieved and stored in the at least one datastore 112.

After receiving the user data from the identified one(s) of the third parties 110, the third party interface module 408 outputs the received user data to the user data datastore interface module 422. The third party interface module 408 is configured to parse and/or otherwise process the user data in accordance with a schema of one or more databases implemented by the at least one datastore 112. For example, the third party interface module 408 can be configured to analyze and/or interpret the user data and parse the analyzed/interpreted user data into one or more data fields as specified by the schema. In such an example, the third party interface module 408 stores the user data in the at least one datastore 112 in association with user identifying information of the user 106 such that the user data can be efficiently retrieved when receiving a request for a data product personalized to the user 106.

FIG. 4B depicts the example implementation of the personalization service 102 shown in FIG. 4A to execute a workflow 430 for authorizing the service provider 104 to request data products personalized to the user 106. In example operation, the authorization API 412 receives an authorization request from the service provider 104. For example, the authorization API 412 can be implemented by one or more APIs configured to expose function(s) to authorize the service provider 104 to request data products in connection with the user 106.

In the illustrated example, the authorization request includes user identification (ID) information and indication(s) of information to be used for data products. In this example, the user ID information includes access credentials (e.g., a username and password, secure data from a one-time passcode (OTP) authenticator application) for the user's account with the personalization service 102. Additionally or alternatively, the user ID information may include a unique identifier identifying the user 106 and/or the user device 108. In this example, the indication of information to be used for data products includes an identification of certain portion(s) of the user's data from certain one(s) of the third parties 110.

In example operation, the authorization API 412 outputs the received data, or portion(s) thereof, to the token generator 416. The token generator 416 and/or, more generally, the authorization module 414, can be configured to generate authorization data, such as tokens (e.g., authorization tokens), based on the received data. In some embodiments, the tokens are one or more strings of alphanumeric text data (e.g., one or more strings of letters and/or numerals). For example, the tokens may be generated using one or more computer hash algorithms using at least part of the received data as data input to generate a token as a data output. In some embodiments, the tokens are web-based tokens such as JavaScript Object Notation (JSON) Web Tokens referred to as JWTs. Other examples of tokens include Keycloak tokens and OAuth2 tokens. By way of example, portion(s) of the user ID information and/or at least some of the indication(s) of information to be used for data products may be used to generate a token for the service provider 104.

After generating the token, the token generator 416 stores the token as one of the tokens 418. For example, the tokens 418 can be a database (e.g., a token database) for storage of generated tokens and/or associated data. Additionally or alternatively, the tokens 418 may represent a list of the generated tokens and/or associated data. Examples of the associated data include the user ID information, the indication(s) of information to be used for data products, information identifying the service provider 104, and an expiration date (e.g., a calendar date and timestamp) upon which a token is to be discarded such as to revoke (or cause revocation of) service provider access. After storing the token generated for the service provider 104 as one of the tokens 418, the authorization module 414 outputs the token to the authorization API 412. The authorization API 412 subsequently provides the token to the service provider 104.

FIG. 4C depicts the example implementation of the personalization service 102 shown in FIG. 4A to execute a workflow 440 for generating a data product personalized to the user 106. In example operation, the service provider API 410 receives, from the service provider 104 and via at least one communication network, a request for a data product personalized to the user 106. For example, the service provider API 410 can be implemented by one or more APIs configured to expose function(s) to receive requests for data products from the service provider 104 and output the generated data products to the service provider 104. In such an example, at least one of the one or more APIs can be a proxy API.

In example operation, the service provider API 410 determines that the request includes (i) information identifying or that can be used to identify at least one data source storing user data for the user 106, such as at least one of the third parties 110, that the user 106 has authorized the personalization service 102 to access and (ii) information indicating how to transform at least some of the user data to generate the data product personalized to the user 106. In example operation, the service provider API 410 outputs the information identifying the user data requested to the user data datastore interface module 422. The service provider API 410 of this example also extracts a token from the request and outputs the token to the token mapper 420. The token mapper 420 can be configured to verify an extracted token, such as the token from the request, by comparing the extracted token to the tokens 418. After determining that the token matches one of the tokens 418, the token mapper 420 authorizes the user data datastore interface module 422 to query for the requested user data. Alternatively, if the token does not match one of the tokens 418, such as in the case that the user 106 has revoked the service provider's access to the user's data products, the token mapper 420 does not authorize the user data datastore interface module 422 to query for the requested user data.

In the illustrated example, the user data datastore interface module 422 obtains, using the information identifying or that can be used to identify the at least one data source, at least some of the user data from, or previously retrieved from, the at least one data source. For example, the user data datastore interface module 422 can be configured to query for user data from the at least one datastore 112 and provide returned user data to the data transformation service interface module 406. In the shown example, the user data datastore interface module 422 obtains the requested user data from, or previously retrieved from, one(s) of the third parties 110 by retrieving the requested user data from the at least one datastore 112. The user data datastore interface module 422 of the shown example provides the returned user data, which is to be used for transformation into the requested data product, to the data transformation service interface module 406.

The data transformation service interface module 406 of the example of FIG. 4C can be configured to generate data products personalized to the user 106 by causing the data transformation service 116 to transform the returned user data into the data product personalized to the user 106. For example, the data transformation service interface module 406 can generate, using the information indicating how to transform the at least some of the user data and the data transformation service 116, the data product personalized to the user 106. In such an example, the data transformation service 116 can execute an LLM using the user data and transformation instructions as data inputs to generate data outputs, which can be and/or include the data product personalized to the user 106. Additionally or alternatively, the data transformation service 116 may execute the LLM using information from the service provider 104 and associated with the service provider 104 (e.g., a list of candidate products for ranking, a list of services offered by the service provider 104). Although not shown for clarity, the data transformation service interface module 406 can receive the information indicating how to transform the at least some of the user data from at least one of the service provider API 410 or the user data datastore interface module 422.

The data transformation service 116 returns the data product personalized to the user 106 to the data transformation service interface module 406, which, in turn, outputs the generated data product to the user data privacy preference module 404. In some embodiments, the user data privacy preference module 404 can be configured to adjust, alter, modify, and/or otherwise change the generated data product in accordance with data privacy preferences of the user 106. For example, the user data privacy preference module 404 can remove PII, sensitive financial information, or other type(s) of information specified by the user 106 not to be shared with the service provider 104 (and/or any other service provider). Alternatively, the user 106 may not have data privacy preferences such that the user data privacy preference module 404 may pass through and/or otherwise output the data product to the service provider 104 via the service provider API 410 without changes.

The service provider API 410 receives the data product personalized to the user 106 (either changed or unchanged by the user data privacy preference module 404). The service provider API 410 of this example provides, to the service provider 104 and via the at least one communication network, the generated data product personalized to the user 106.

While an example implementation of the personalization service 102 is depicted in FIGS. 4A, 4B, and 4C, other implementations are contemplated. For example, one or more blocks, components, functions, etc., of the implementations of the personalization service 102 shown in FIGS. 4A, 4B, and 4C may be combined or divided in any other way. The personalization service 102 of the illustrated example of FIGS. 4A, 4B, and 4C may be implemented by hardware alone, or by a combination of hardware, software, and/or firmware. For example, the personalization service 102 of FIGS. 4A, 4B, and 4C may be implemented by one or more analog or digital circuits (e.g., comparators, operational amplifiers, etc.), one or more hardware-implemented state machines, one or more programmable processors (e.g., central processing units (CPUs), digital signal processors (DSPs), field programmable gate arrays (FPGAs), graphics processing units (GPUs), etc.), one or more network interfaces (e.g., network interface circuitry, network interface cards (NICs), smart NICs, etc.), one or more application specific integrated circuits (ASICs), one or more memories (e.g., non-volatile memory, volatile memory, etc.), one or more mass storage disks or devices (e.g., hard-disk drives (HDDs), solid-state disk (SSD) drives, etc.), etc., and/or any combination(s) thereof.

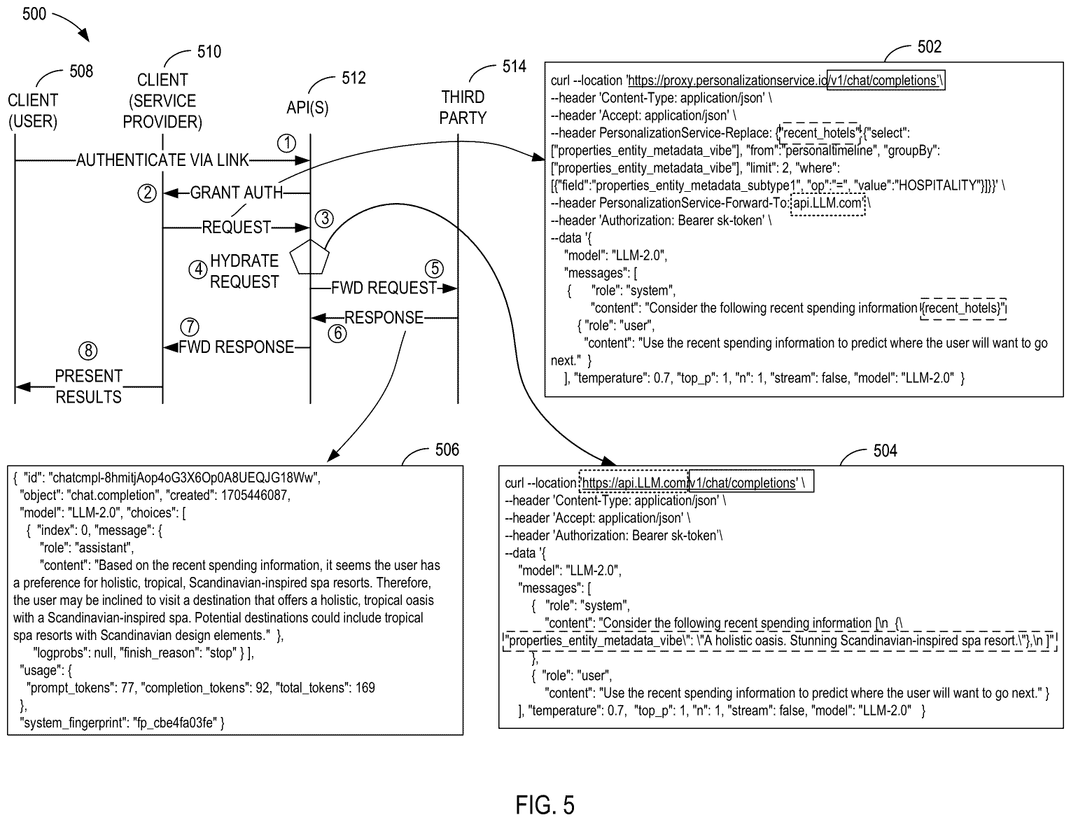

FIG. 5 is an example data flow diagram 500 with corresponding example pseudocode 502, 504, 506 for generating a data product personalized to a user. The data flow diagram 500 includes operations in connection with a first client 508, a second client 510, API(s) 512, and a third party 514. In some embodiments, the first client 508 corresponds to a user, such as the user 106. In some embodiments, the second client 510 corresponds to a service provider, such as the service provider 104. In some embodiments, the API(s) 512 correspond to one or more APIs, such as the service provider API 410 and/or the authorization API 412. In some embodiments, the third party 514 corresponds to one(s) of the third parties 110.

During one or more first operations of the data flow diagram 500 (identified by “1”), the first client 508 either creates or logs into an account managed by the personalization service 102 via an embeddable link GUI. Additionally or alternatively, the first client 508 may provide consent configurations to control application data access, such as access to user data hosted by third parties.

During one or more second operations of the data flow diagram 500 (identified by “2”), after validating the provided information from both the first client 508 and the second client 510, a short-lived authorization token is provided, conferring access to the API(s) 512 on behalf of the first client 508.

During one or more third operations of the data flow diagram 500 (identified by “3”), the second client 510 then creates templated requests, and provides settings for how the variables are resolved and replaced in the headers. As shown in pseudocode 502, the template variable syntax is single curly brackets (e.g., “This is a template (variable)”). Depicted in the pseudocode 502, the query object is provided in a header named “PersonalizationService-Replace”. Also shown in the pseudocode 502, the query object is a JSON object representing a dictionary of variable-query pairs. Queries are either a parsed JSON object or a SQL query. However, this disclosure is not limited to JSON or SQL implementations as any type of database and/or data query technology may be used.

In the example of FIG. 5, the templated request is for an LLM (identified by “LLM-2.0” in pseudocode 502, 504, 506) to process a prompt (identified by the “role” and “content” portions of pseudocode 502, 504) using requested portion(s) of the user data (identified by “recent_hotels” in pseudocode 502), which is replaced by the user data (identified by “properties_entity_metadata_vibe . . . ” in pseudocode 504) from the at least one datastore 112 of FIG. 1A.

During one or more fourth operations of the data flow diagram 500 (identified by “4”), the hydration queries are parsed, resolved, and formatted before being replaced inside the request. During one or more fifth operations of the data flow diagram 500 (identified by “5”), the request is then forwarded to the destination provided in the request headers. As shown in pseudocode 502, the destination is provided in a header named “PersonalizationService-Forward-To”. During one or more sixth operations of the data flow diagram 500 (identified by “6”), a response from the destination is returned to the API(s) 512. As shown in pseudocode 506, the data product personalized to the user 106 is identified by the “content” data field (e.g., “Based on the recent spending information . . . Potential destinations could include tropical spa resorts with Scandinavian design elements.”).

During one or more seventh operations of the data flow diagram 500 (identified by “7”), after an opportunity to filter and/or format data according to a user's data privacy settings and/or preferences, the result is returned to the second client 510. During one or more eighth operations of the data flow diagram 500 (identified by “8”), the output from the API(s) 512 is formatted and displayed to a user via the first client 508.

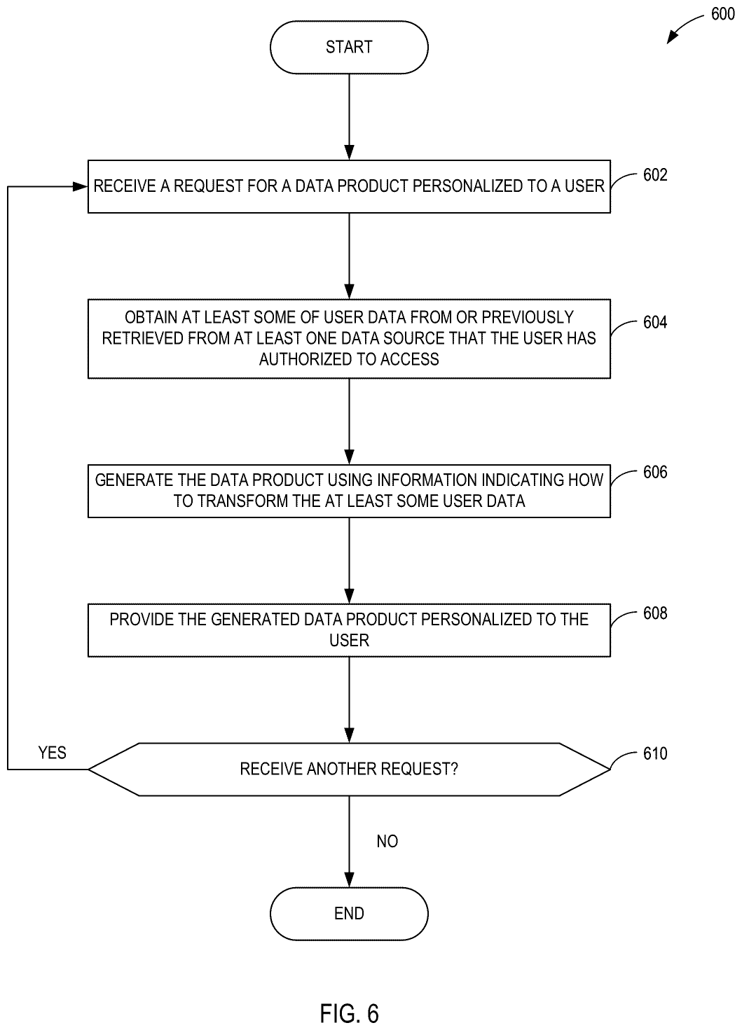

FIG. 6 is a flowchart 600 representative of an example process that may be performed and/or implemented using hardware logic and/or example machine-readable instructions that may be executed by processor circuitry to implement the personalization service 102 of FIGS. 1A, 1B, 2, 3, 4A, 4B, and/or 4C. The flowchart 600 of FIG. 6 begins at block 602, at which the personalization service 102 receives a request for a data product personalized to a user. For example, the service provider API 410 can receive a request from the service provider 104 for a data product, such as a recommendation to the user 106 for a product and/or service to be purchased, personalized to the user 106.

At block 604, the personalization service 102 obtains at least some of user data from, or previously retrieved from, at least one data source that the user has authorized to access. For example, the user data datastore interface module 422 can retrieve user data from the at least one datastore 112. In some embodiments, the user data is from the third parties 110 via dynamic retrieval, such as by being retrieved in response to receiving a request from the service provider 104. In some embodiments, the user data is previously retrieved from the third parties 110, such as by being prefetched prior to receiving the request (e.g., when the user 106 signed up for an account with the personalization service 102 or periodically thereafter and before the request is received).

At block 606, the personalization service 102 generates the data product using information indicating how to transform the at least some user data. For example, the data transformation service interface module 406 can generate, using the information from the service provider 104 indicating how to transform the user data retrieved from the at least one datastore 112 and using the LLM service 116A, the data product personalized to the user 106.

At block 608, the personalization service 102 provides the generated data product personalized to the user. For example, the service provider API 410 can provide the generated data product, such as the recommendation to the user 106 for a product and/or service to be purchased that comports with and/or otherwise is in accordance with the user's data, to the user 106 via the service provider 104.

At block 610, the personalization service 102 determines whether another request is received. For example, the service provider API 410 can determine whether another request for a data product personalized to the user 106 or different user(s) is/are received. If, at block 610, the personalization service 102 determines that another request is received, control returns to block 602. Otherwise, the example flowchart 600 of FIG. 6 concludes.

FIG. 7 is an example implementation of an electronic platform 700 structured to execute the machine-readable instructions of FIG. 6 to implement the personalization service 102 of FIGS. 1A, 1B, 2, 3, 4A, 4B, and/or 4C. It should be appreciated that FIG. 7 is intended neither to be a description of necessary components for an electronic and/or computing device to operate as a personalization service, in accordance with the techniques described herein, nor a comprehensive depiction. The electronic platform 700 of this example may be an electronic device, such as a desktop computer, a server (e.g., a computer server, a blade server, a rack-mounted server, etc.), a workstation, or any other type of computing and/or electronic device.

The electronic platform 700 of the illustrated example includes processor circuitry 702, which may be implemented by one or more programmable processors, one or more hardware-implemented state machines, one or more ASICs, etc., and/or any combination(s) thereof. For example, the one or more programmable processors may include one or more CPUs, one or more DSPs, one or more FPGAs, one or more GPUs, etc., and/or any combination(s) thereof. The processor circuitry 702 includes processor memory 704, which may be volatile memory, such as random-access memory (RAM) of any type. The processor circuitry 702 of this example implements the user data privacy preference module 404, the authorization module 414, the token generator 416, and the token mapper 420 of FIGS. 4A, 4B, and 4C.

The processor circuitry 702 may execute machine-readable instructions 706 (identified by INSTRUCTIONS), which are stored in the processor memory 704, to implement at least one of the user data privacy preference module 404, the authorization module 414, the token generator 416, or the token mapper 420 of FIGS. 4A, 4B, and 4C. The machine-readable instructions 706 may include data representative of computer-executable and/or machine-executable instructions implementing techniques that operate according to the techniques described herein. For example, the machine-readable instructions 706 may include data (e.g., code, embedded software (e.g., firmware), software, etc.) representative of the flowchart of FIG. 6, or portion(s) thereof.

The electronic platform 700 includes memory 708, which may include the instructions 706. The memory 708 of this example may be controlled by a memory controller 710. For example, the memory controller 710 may control reads, writes, and/or, more generally, access(es) to the memory 708 by other component(s) of the electronic platform 700. The memory 708 of this example may be implemented by volatile memory, non-volatile memory, etc., and/or any combination(s) thereof. For example, the volatile memory may include static random-access memory (SRAM), dynamic random-access memory (DRAM), cache memory (e.g., Level 1 (L1) cache memory, Level 2 (L2) cache memory, Level 3 (L3) cache memory, etc.), etc., and/or any combination(s) thereof. In some examples, the non-volatile memory may include Flash memory, electrically erasable programmable read-only memory (EEPROM), magnetoresistive random-access memory (MRAM), ferroelectric random-access memory (FeRAM, F-RAM, or FRAM), etc., and/or any combination(s) thereof.

The electronic platform 700 includes input device(s) 712 to enable data and/or commands to be entered into the processor circuitry 702. For example, the input device(s) 712 may include an audio sensor, a camera (e.g., a still camera, a video camera, etc.), a keyboard, a microphone, a mouse, a touchscreen, a voice recognition system, etc., and/or any combination(s) thereof.

The electronic platform 700 includes output device(s) 714 to convey, display, and/or present information to a user (e.g., a human user, a machine user, etc.). For example, the output device(s) 714 may include one or more display devices, speakers, etc. The one or more display devices may include an augmented reality (AR) and/or virtual reality (VR) display, a liquid crystal display (LCD), a light-emitting diode (LED) display, an organic light-emitting diode (OLED) display, a quantum dot (QLED) display, a thin-film transistor (TFT) LCD, a touchscreen, etc., and/or any combination(s) thereof. The output device(s) 714 can be used, among other things, to generate, launch, and/or present a user interface. For example, the user interface may be generated and/or implemented by the output device(s) 714 for visual presentation of output and speakers or other sound generating devices for audible presentation of output.

The electronic platform 700 includes accelerators 716, which are hardware devices to which the processor circuitry 702 may offload compute tasks to accelerate their processing. For example, the accelerators 716 may include artificial intelligence/machine-learning (AI/ML) processors, ASICs, FPGAs, graphics processing units (GPUs), neural network (NN) processors, systems-on-chip (SoCs), vision processing units (VPUs), etc., and/or any combination(s) thereof. In some examples, one or more of the user data privacy preference module 404, the authorization module 414, the token generator 416, and/or the token mapper 420 may be implemented by one(s) of the accelerators 716 instead of the processor circuitry 702. In some examples, the user data privacy preference module 404, the authorization module 414, the token generator 416, and/or the token mapper 420 may be executed concurrently (e.g., in parallel, substantially in parallel, etc.) by the processor circuitry 702 and the accelerators 716. For example, the processor circuitry 702 and one(s) of the accelerators 716 may execute in parallel function(s) corresponding to the token generator 416.

The electronic platform 700 includes storage 718 to record and/or control access to data, such as the machine-readable instructions 706. In this example, the storage 718 implements the tokens 418 of FIGS. 4A, 4B, and 4C. Additionally or alternatively, the storage 718 may implement the user data for the plurality of users 114 and/or, more generally, the at least one datastore 112 of FIGS. 4A, 4B, and 4C. The storage 718 may be implemented by one or more mass storage disks or devices, such as HDDs, SSDs, etc., and/or any combination(s) thereof.

The electronic platform 700 includes interface(s) 720 to effectuate exchange of data with external devices (e.g., computing and/or electronic devices of any kind) via a network 722. In this example, the interface(s) 720 implement(s) the user device interface module 402, the data transformation service interface module 406 (identified by DATA TRANSFORM SERVICE I/F MODULE), the third party interface module 408, the service provider API 410, the authorization API 412, and the user data datastore interface module 422 (identified by USER DATA DATASTORE I/F MODULE) of FIGS. 4A, 4B, and 4C. The interface(s) 720 of the illustrated example may be implemented by an interface device, such as network interface circuitry (e.g., a NIC, a smart NIC, etc.), a gateway, a router, a switch, etc., and/or any combination(s) thereof. The interface(s) 720 may implement any type of communication interface, such as BLUETOOTH®, a cellular telephone system (e.g., a 4G LTE interface, a 5G interface, a future generation 6G interface, etc.), an Ethernet interface, a near-field communication (NFC) interface, an optical disc interface (e.g., a Blu-ray disc drive, a Compact Disk (CD) drive, a Digital Versatile Disk (DVD) drive, etc.), an optical fiber interface, a satellite interface (e.g., a BLOS satellite interface, a LOS satellite interface, etc.), a Universal Serial Bus (USB) interface (e.g., USB Type-A, USB Type-B, USB TYPE-C™ or USB-C™, etc.), etc., and/or any combination(s) thereof.

The electronic platform 700 includes a power supply 724 to store energy and provide power to components of the electronic platform 700. The power supply 724 may be implemented by a power converter, such as an alternating current-to-direct-current (AC/DC) power converter, a direct current-to-direct current (DC/DC) power converter, etc., and/or any combination(s) thereof. For example, the power supply 724 may be powered by an external power source, such as an alternating current (AC) power source (e.g., an electrical grid), a direct current (DC) power source (e.g., a battery, a battery backup system, etc.), etc., and the power supply 724 may convert the AC input or the DC input into a suitable voltage for use by the electronic platform 700. In some examples, the power supply 724 may be a limited duration power source, such as a battery (e.g., a rechargeable battery such as a lithium-ion battery).

Component(s) of the electronic platform 700 may be in communication with one(s) of each other via a bus 726. For example, the bus 726 may be any type of computing and/or electrical bus, such as an I2C bus, a PCI bus, a PCIe bus, a SPI bus, and/or the like.

The network 722 may be implemented by any wired and/or wireless network(s) such as one or more cellular networks (e.g., 4G LTE cellular networks, 5G cellular networks, future generation 6G cellular networks, etc.), one or more data buses, one or more local area networks (LANs), one or more optical fiber networks, one or more private networks, one or more public networks, one or more wireless local area networks (WLANs), etc., and/or any combination(s) thereof. For example, the network 722 may be the Internet, but any other type of private and/or public network is contemplated.

The network 722 of the illustrated example facilitates communication between the interface(s) 720 and a central facility 728. The central facility 728 in this example may be an entity associated with one or more servers, such as one or more physical hardware servers and/or virtualizations of the one or more physical hardware servers. For example, the central facility 728 may be implemented by a public cloud provider, a private cloud provider, etc., and/or any combination(s) thereof. In this example, the central facility 728 may compile, generate, update, etc., the machine-readable instructions 706 and store the machine-readable instructions 706 for access (e.g., download) via the network 722. For example, the electronic platform 700 may transmit a request, via the interface(s) 720, to the central facility 728 for the machine-readable instructions 706 and receive the machine-readable instructions 706 from the central facility 728 via the network 722 in response to the request.

Additionally or alternatively, the interface(s) 720 may receive the machine-readable instructions 706 via non-transitory machine-readable storage media, such as an optical disc 730 (e.g., a Blu-ray disc, a CD, a DVD, etc.) or any other type of removable non-transitory machine-readable storage media such as a USB drive 732. For example, the optical disc 730 and/or the USB drive 732 may store the machine-readable instructions 706 thereon and provide the machine-readable instructions 706 to the electronic platform 700 via the interface(s) 720.

Techniques operating according to the principles described herein may be implemented in any suitable manner. The processing and decision blocks of the flowcharts above represent steps and acts that may be included in algorithms that carry out these various processes. Algorithms derived from these processes may be implemented as software integrated with and directing the operation of one or more single- or multi-purpose processors, may be implemented as functionally equivalent circuits such as a DSP circuit or an ASIC, or may be implemented in any other suitable manner. It should be appreciated that the flowcharts included herein do not depict the syntax or operation of any particular circuit or of any particular programming language or type of programming language. Rather, the flowcharts illustrate the functional information one skilled in the art may use to fabricate circuits or to implement computer software algorithms to perform the processing of a particular apparatus carrying out the types of techniques described herein. For example, the flowcharts, or portion(s) thereof, may be implemented by hardware alone (e.g., one or more analog or digital circuits, one or more hardware-implemented state machines, etc., and/or any combination(s) thereof) that is configured or structured to carry out the various processes of the flowcharts. In some examples, the flowcharts, or portion(s) thereof, may be implemented by machine-executable instructions (e.g., machine-readable instructions, computer-readable instructions, computer-executable instructions, etc.) that, when executed by one or more single- or multi-purpose processors, carry out the various processes of the flowcharts. It should also be appreciated that, unless otherwise indicated herein, the particular sequence of steps and/or acts described in each flowchart is merely illustrative of the algorithms that may be implemented and can be varied in implementations and embodiments of the principles described herein.

Accordingly, in some embodiments, the techniques described herein may be embodied in machine-executable instructions implemented as software, including as application software, system software, firmware, middleware, embedded code, or any other suitable type of computer code. Such machine-executable instructions may be generated, written, etc., using any of a number of suitable programming languages and/or programming or scripting tools, and also may be compiled as executable machine language code or intermediate code that is executed on a framework, virtual machine, or container.

When techniques described herein are embodied as machine-executable instructions, these machine-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc., that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application.

Some exemplary functional facilities have been described herein for carrying out one or more tasks. It should be appreciated, though, that the functional facilities and division of tasks described is merely illustrative of the type of functional facilities that may implement using the exemplary techniques described herein, and that embodiments are not limited to being implemented in any specific number, division, or type of functional facilities. In some implementations, all functionalities may be implemented in a single functional facility. It should also be appreciated that, in some implementations, some of the functional facilities described herein may be implemented together with or separately from others (e.g., as a single unit or separate units), or some of these functional facilities may not be implemented.

Machine-executable instructions (e.g., processor-executable instructions or processor-executable instructions) implementing the techniques described herein (when implemented as one or more functional facilities or in any other manner) may, in some embodiments, be encoded on one or more computer-readable media, machine-readable media, etc., to provide functionality to the media. Computer-readable media, machine-readable media, etc., include magnetic media such as a hard disk drive, optical media such as a CD or a DVD, a persistent or non-persistent solid-state memory (e.g., Flash memory, Magnetic RAM, etc.), or any other suitable storage media. Such a computer-readable medium, a machine-readable medium, etc., may be implemented in any suitable manner. As used herein, the terms “computer-readable media” (also called “computer-readable storage media”), “computer-readable medium” (also called “computer-readable storage medium”), “machine-readable media” (also called “machine-readable storage media”), and “machine-readable medium” (also called “machine-readable storage medium”) refer to tangible storage media. Tangible storage media are non-transitory and have at least one physical, structural component. In a “computer-readable medium” and “machine-readable medium” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium, a machine-readable medium, etc., may be altered during a recording process.

Further, some techniques described above comprise acts of storing information (e.g., data and/or instructions) in certain ways for use by these techniques. In some implementations of these techniques—such as implementations where the techniques are implemented as machine-executable instructions—the information may be encoded on a computer-readable storage media. Where specific structures are described herein as advantageous formats in which to store this information, these structures may be used to impart a physical organization of the information when encoded on the storage medium. These advantageous structures may then provide functionality to the storage medium by affecting operations of one or more processors interacting with the information; for example, by increasing the efficiency of computer operations performed by the processor(s).

In some, but not all, implementations in which the techniques may be embodied as machine-executable instructions, these instructions may be executed on one or more suitable computing device(s) and/or electronic device(s) operating in any suitable computer and/or electronic system, or one or more computing devices (or one or more processors of one or more computing devices) and/or one or more electronic devices (or one or more processors of one or more electronic devices) may be programmed to execute the machine-executable instructions. A computing device, electronic device, or processor (e.g., processor circuitry) may be programmed to execute instructions when the instructions are stored in a manner accessible to the computing device, electronic device, or processor, such as in a data store (e.g., an on-chip cache or instruction register, a computer-readable storage medium and/or a machine-readable storage medium accessible via a bus, a computer-readable storage medium and/or a machine-readable storage medium accessible via one or more networks and accessible by the device/processor, etc.). Functional facilities comprising these machine-executable instructions may be integrated with and direct the operation of a single multi-purpose programmable digital computing device, a coordinated system of two or more multi-purpose computing device sharing processing power and jointly carrying out the techniques described herein, a single computing device or coordinated system of computing device (co-located or geographically distributed) dedicated to executing the techniques described herein, one or more FPGAs for carrying out the techniques described herein, or any other suitable system.

Embodiments have been described where the techniques are implemented in circuitry and/or machine-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

The phrase “and/or,” as used herein in the specification and in the claims, should be understood to mean “either or both,” of the elements so conjoined, e.g., elements that are conjunctively present in some cases and disjunctively present in other cases. Multiple elements listed with “and/or” should be construed in the same fashion, e.g., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

The indefinite articles “a” and “an,” as used herein in the specification and in the claims, unless clearly indicated to the contrary, should be understood to mean “at least one.”

As used herein in the specification and in the claims, the phrase, “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently, “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

All definitions, as defined and used herein, should be understood to control over dictionary definitions, definitions in documents incorporated by reference, and/or ordinary meanings of the defined terms.

The word “exemplary” is used herein to mean serving as an example, instance, or illustration. Any embodiment, implementation, process, feature, etc., described herein as exemplary should therefore be understood to be an illustrative example and should not be understood to be a preferred or advantageous example unless otherwise indicated.

Having thus described several aspects of at least one embodiment, it is to be appreciated that various alterations, modifications, and improvements will readily occur to those skilled in the art. Such alterations, modifications, and improvements are intended to be part of this disclosure and are intended to be within the spirit and scope of the principles described herein. Accordingly, the foregoing description and drawings are by way of example only.

Various aspects are described in this disclosure, which include, but are not limited to, the following aspects:
1. A system for generating, by a data product personalization service and for a service provider, a data product personalized to a user with whom the service provider is to interact, the system comprising: at least one hardware processor; and at least one computer-readable storage medium storing processor-executable instructions that, when executed by the at least one hardware processor, cause the at least one hardware processor to perform a method comprising: (A) receiving, from the service provider and via at least one communication network, a request for the data product personalized to the user, the request comprising: (i) information identifying or that can be used to identify at least one data source storing user data for the user that the user has authorized the data product personalization service to access; and (ii) information indicating how to transform at least some of the user data to generate the data product personalized to the user; (B) obtaining, using the information identifying or that can be used to identify the at least one data source, the at least some of the user data from, or previously retrieved from, the at least one data source; (C) generating, using the information indicating how to transform the at least some of the user data and a data transformation service, the data product personalized to the user; and (D) providing, to the service provider and via the at least one communication network, the generated data product personalized to the user.
2. The system of aspect 1, wherein the data transformation service comprises a generative machine learning (ML) model, and wherein generating the data product personalized to the user comprises: causing the data transformation service to process the at least some of the user data with the generative ML model based on the information indicating how to transform the at least some of the user data.
3. The system of aspect 1, wherein the data transformation service comprises a generative machine learning (ML) model, and wherein generating the data product personalized to the user comprises: generating ML input using the at least some of the user data and the information indicating how to transform the at least some of the user data; providing the ML input to the data transformation service for processing by the generative ML model to obtain a respective output; and receiving the respective output from the data transformation service.
4. The system of aspect 2 or 3, wherein the generative machine learning model is a large language model (LLM).
5. The system of aspect 4, wherein generating the ML input comprises generating a prompt for the LLM using the at least some of the user data and the information indicating how to transform the at least some of the user data.
6. The system of aspect 3, wherein the processor-executable instructions further cause the at least one hardware processor to perform providing the respective output from the data transformation service to the service provider as the generated data product personalized to the user.
7. The system of aspect 1, wherein the processor-executable instructions further cause the at least one hardware processor to perform: receiving, from the user via at the at least one communication network, authorization for the data product personalization service to obtain the at least some of the user data from the at least one data source; obtaining the at least some of the user data from the at least one data source via the at least one communication network; and storing the at least some of the user data in at least one datastore.
8. The system of aspect 7, wherein storing the at least some of the user data in the at least one datastore comprises storing the at least some of the user data in the at least one datastore such that the at least one datastore is only accessible by the data product personalization service.
9. The system of aspect 7, wherein storing the at least some of the user data in the at least one datastore comprises storing the at least some of the user data in the at least one datastore in accordance with a database schema comprising data fields representing categories of information in the user data.
10. The system of aspect 7, wherein the at least one data source comprises one or more first data sources and one or more second data sources, and wherein receiving authorization for the data product personalization service comprises receiving authorization for the data product personalization service to obtain the at least some of the user data from the one or more first data sources.
11. The system of aspect 1, wherein the processor-executable instructions further cause the at least one hardware processor to perform: receiving, from the service provider and via the at least one communication network, information identifying the user; generating authorization data to represent a data association of the information identifying the user; and providing the authorization data to the service provider for generation of the request for the data product personalized to the user.
12. At least one computer-readable storage medium storing processor-executable instructions that, when executed by at least one hardware processor, cause the at least one hardware processor to perform a method for generating, by a data product personalization service and for a service provider, a data product personalized to a user with whom the service provider is to interact, the method comprising: (A) receiving, from the service provider and via at least one communication network, a request for the data product personalized to the user, the request comprising: (i) information identifying or that can be used to identify at least one data source storing user data for the user that the user has authorized the data product personalization service to access; and (ii) information indicating how to transform at least some of the user data to generate the data product personalized to the user; (B) obtaining, using the information identifying or that can be used to identify the at least one data source, the at least some of the user data from, or previously retrieved from, the at least one data source; (C) generating, using the information indicating how to transform the at least some of the user data and a data transformation service, the data product personalized to the user; and (D) providing, to the service provider and via the at least one communication network, the generated data product personalized to the user.
13. The at least one computer-readable storage medium of aspect 12, wherein the data transformation service comprises a generative machine learning (ML) model, and wherein generating the data product personalized to the user comprises: causing the data transformation service to process the at least some of the user data with the generative ML model based on the information indicating how to transform the at least some of the user data.
14. The at least one computer-readable storage medium of aspect 12, wherein the data transformation service comprises a generative machine learning (ML) model, and wherein generating the data product personalized to the user comprises: generating ML input using the at least some of the user data and the information indicating how to transform the at least some of the user data; providing the ML input to the data transformation service for processing by the generative ML model to obtain a respective output; and receiving the respective output from the data transformation service.
15. The at least one computer-readable storage medium of aspect 13 or 14, wherein the generative machine learning model is a large language model (LLM).
16. The at least one computer-readable storage medium of aspect 15, wherein generating the ML input comprises generating a prompt for the LLM using the at least some of the user data and the information indicating how to transform the at least some of the user data.
17. The at least one computer-readable storage medium of aspect 14, wherein the processor-executable instructions further cause the at least one hardware processor to perform providing the respective output from the data transformation service to the service provider as the generated data product personalized to the user.
18. The at least one computer-readable storage medium of aspect 12, wherein the processor-executable instructions further cause the at least one hardware processor to perform: receiving, from the user via at the at least one communication network, authorization for the data product personalization service to obtain the at least some of the user data from the at least one data source; obtaining the at least some of the user data from the at least one data source via the at least one communication network; and storing the at least some of the user data in at least one datastore.
19. The at least one computer-readable storage medium of aspect 18, wherein storing the at least some of the user data in the at least one datastore comprises storing the at least some of the user data in the at least one datastore such that the at least one datastore is only accessible by the data product personalization service.
20. The at least one computer-readable storage medium of aspect 18, wherein storing the at least some of the user data in the at least one datastore comprises storing the at least some of the user data in the at least one datastore in accordance with a database schema comprising data fields representing categories of information in the user data.
21. The at least one computer-readable storage medium of aspect 18, wherein the at least one data source comprises one or more first data sources and one or more second data sources, and wherein receiving authorization for the data product personalization service comprises receiving authorization for the data product personalization service to obtain the at least some of the user data from the one or more first data sources.
22. The at least one computer-readable storage medium of aspect 12, wherein the processor-executable instructions further cause the at least one hardware processor to perform: receiving, from the service provider and via the at least one communication network, information identifying the user; generating authorization data to represent a data association of the information identifying the user; and providing the authorization data to the service provider for generation of the request for the data product personalized to the user.
23. A method for generating, by a data product personalization service and for a service provider, a data product personalized to a user with whom the service provider is to interact, the method comprising: using software of the data product personalization service executing on at least one computer hardware processor to perform: (A) receiving, from the service provider and via at least one communication network, a request for the data product personalized to the user, the request comprising: (i) information identifying or that can be used to identify at least one data source storing user data for the user that the user has authorized the data product personalization service to access; and (ii) information indicating how to transform at least some of the user data to generate the data product personalized to the user; (B) obtaining, using the information identifying or that can be used to identify the at least one data source, the at least some of the user data from, or previously retrieved from, the at least one data source; (C) generating, using the information indicating how to transform the at least some of the user data and a data transformation service, the data product personalized to the user; and (D) providing, to the service provider and via the at least one communication network, the generated data product personalized to the user.
24. The method of aspect 23, wherein the data transformation service comprises a generative machine learning (ML) model, and wherein generating the data product personalized to the user comprises: causing the data transformation service to process the at least some of the user data with the generative ML model based on the information indicating how to transform the at least some of the user data.
25. The method of aspect 23, wherein the data transformation service comprises a generative machine learning (ML) model, and wherein generating the data product personalized to the user comprises: generating ML input using the at least some of the user data and the information indicating how to transform the at least some of the user data; providing the ML input to the data transformation service for processing by the generative ML model to obtain a respective output; and receiving the respective output from the data transformation service.
26. The method of aspect 24 or 25, wherein the generative machine learning model is a large language model (LLM).
27. The method of aspect 26, wherein generating the ML input comprises generating a prompt for the LLM using the at least some of the user data and the information indicating how to transform the at least some of the user data.
28. The method of aspect 25, further comprising providing the respective output from the data transformation service to the service provider as the generated data product personalized to the user.
29. The method of aspect 23, further comprising: receiving, from the user via at the at least one communication network, authorization for the data product personalization service to obtain the at least some of the user data from the at least one data source; obtaining the at least some of the user data from the at least one data source via the at least one communication network; and storing the at least some of the user data in at least one datastore.
30. The method of aspect 29, wherein storing the at least some of the user data in the at least one datastore comprises storing the at least some of the user data in the at least one datastore such that the at least one datastore is only accessible by the data product personalization service.
31. The method of aspect 29, wherein storing the at least some of the user data in the at least one datastore comprises storing the at least some of the user data in the at least one datastore in accordance with a database schema comprising data fields representing categories of information in the user data.
32. The method of aspect 29, wherein the at least one data source comprises one or more first data sources and one or more second data sources, and wherein receiving authorization for the data product personalization service comprises receiving authorization for the data product personalization service to obtain the at least some of the user data from the one or more first data sources.
33. The method of aspect 23, further comprising: receiving, from the service provider and via the at least one communication network, information identifying the user; generating authorization data to represent a data association of the information identifying the user; and providing the authorization data to the service provider for generation of the request for the data product personalized to the user.

1. A system for generating, by a data product personalization service and for a service provider, a data product personalized to a user with whom the service provider is to interact, the system comprising:
at least one hardware processor; and
at least one computer-readable storage medium storing processor-executable instructions that, when executed by the at least one hardware processor, cause the at least one hardware processor to perform a method comprising:
(A) receiving, from the service provider and via at least one communication network, a request for the data product personalized to the user, the request comprising:
(i) information identifying or that can be used to identify at least one data source storing user data for the user that the user has authorized the data product personalization service to access; and
(ii) information indicating how to transform at least some of the user data to generate the data product personalized to the user;
(B) obtaining, using the information identifying or that can be used to identify the at least one data source, the at least some of the user data from, or previously retrieved from, the at least one data source;
(C) generating, using the information indicating how to transform the at least some of the user data and a data transformation service, the data product personalized to the user; and
(D) providing, to the service provider and via the at least one communication network, the generated data product personalized to the user.

2. The system of claim 1,
wherein the data transformation service comprises a generative machine learning (ML) model, and
wherein generating the data product personalized to the user comprises:
causing the data transformation service to process the at least some of the user data
with the generative ML model based on the information indicating how to transform the at least some of the user data.

3. The system of claim 1,
wherein the data transformation service comprises a generative machine learning (ML) model, and
wherein generating the data product personalized to the user comprises:
generating ML input using the at least some of the user data and the information indicating how to transform the at least some of the user data;
providing the ML input to the data transformation service for processing by the generative ML model to obtain a respective output; and
receiving the respective output from the data transformation service.

4. The system of claim 3, wherein the generative machine learning model is a large language model (LLM).

5. The system of claim 4,
wherein generating the ML input comprises generating a prompt for the LLM using the at least some of the user data and the information indicating how to transform the at least some of the user data.

6. The system of claim 3,
wherein the processor-executable instructions further cause the at least one hardware processor to perform providing the respective output from the data transformation service to the service provider as the generated data product personalized to the user.

7-10. (canceled)

11. The system of claim 1, wherein the processor-executable instructions further cause the at least one hardware processor to perform:
receiving, from the service provider and via the at least one communication network, information identifying the user;
generating authorization data to represent a data association of the information identifying the user; and
providing the authorization data to the service provider for generation of the request for the data product personalized to the user.

12. At least one computer-readable storage medium storing processor-executable instructions that, when executed by at least one hardware processor, cause the at least one hardware processor to perform a method for generating, by a data product personalization service and for a service provider, a data product personalized to a user with whom the service provider is to interact, the method comprising:
(A) receiving, from the service provider and via at least one communication network, a request for the data product personalized to the user, the request comprising:
(i) information identifying or that can be used to identify at least one data source storing user data for the user that the user has authorized the data product personalization service to access; and
(ii) information indicating how to transform at least some of the user data to generate the data product personalized to the user;
(B) obtaining, using the information identifying or that can be used to identify the at least one data source, the at least some of the user data from, or previously retrieved from, the at least one data source;
(C) generating, using the information indicating how to transform the at least some of the user data and a data transformation service, the data product personalized to the user; and
(D) providing, to the service provider and via the at least one communication network, the generated data product personalized to the user.

13. The at least one computer-readable storage medium of claim 12,
wherein the data transformation service comprises a generative machine learning (ML) model, and
wherein generating the data product personalized to the user comprises:
causing the data transformation service to process the at least some of the user data with the generative ML model based on the information indicating how to transform the at least some of the user data.

14. The at least one computer-readable storage medium of claim 12,
wherein the data transformation service comprises a generative machine learning (ML) model, and
wherein generating the data product personalized to the user comprises:
generating ML input using the at least some of the user data and the information indicating how to transform the at least some of the user data;
providing the ML input to the data transformation service for processing by the generative ML model to obtain a respective output; and
receiving the respective output from the data transformation service.

15-17. (canceled)

18. The at least one computer-readable storage medium of claim 12, wherein the processor-executable instructions further cause the at least one hardware processor to perform:
receiving, from the user via at the at least one communication network, authorization for the data product personalization service to obtain the at least some of the user data from the at least one data source;
obtaining the at least some of the user data from the at least one data source via the at least one communication network; and
storing the at least some of the user data in at least one datastore.

19. The at least one computer-readable storage medium of claim 18,
wherein storing the at least some of the user data in the at least one datastore comprises storing the at least some of the user data in the at least one datastore such that the at least one datastore is only accessible by the data product personalization service.

20. The at least one computer-readable storage medium of claim 18,
wherein storing the at least some of the user data in the at least one datastore comprises storing the at least some of the user data in the at least one datastore in accordance with a database schema comprising data fields representing categories of information in the user data.

21. The at least one computer-readable storage medium of claim 18,
wherein the at least one data source comprises one or more first data sources and one or more second data sources, and
wherein receiving authorization for the data product personalization service comprises receiving authorization for the data product personalization service to obtain the at least some of the user data from the one or more first data sources.

22. (canceled)

23. A method for generating, by a data product personalization service and for a service provider, a data product personalized to a user with whom the service provider is to interact, the method comprising:
using software of the data product personalization service executing on at least one computer hardware processor to perform:
(A) receiving, from the service provider and via at least one communication network, a request for the data product personalized to the user, the request comprising:
(i) information identifying or that can be used to identify at least one data source storing user data for the user that the user has authorized the data product personalization service to access; and
(ii) information indicating how to transform at least some of the user data to generate the data product personalized to the user;
(B) obtaining, using the information identifying or that can be used to identify the at least one data source, the at least some of the user data from, or previously retrieved from, the at least one data source;
(C) generating, using the information indicating how to transform the at least some of the user data and a data transformation service, the data product personalized to the user; and
(D) providing, to the service provider and via the at least one communication network, the generated data product personalized to the user.

24. The method of claim 23,
wherein the data transformation service comprises a generative machine learning (ML) model, and
wherein generating the data product personalized to the user comprises:
causing the data transformation service to process the at least some of the user data with the generative ML model based on the information indicating how to transform the at least some of the user data.

25. The method of claim 23,
wherein the data transformation service comprises a generative machine learning (ML) model, and
wherein generating the data product personalized to the user comprises:
generating ML input using the at least some of the user data and the information indicating how to transform the at least some of the user data;
providing the ML input to the data transformation service for processing by the generative ML model to obtain a respective output; and
receiving the respective output from the data transformation service.

26. The method of claim 25, wherein the generative machine learning model is a large language model (LLM).

27. The method of claim 26,
wherein generating the ML input comprises generating a prompt for the LLM using the at least some of the user data and the information indicating how to transform the at least some of the user data.

28. (canceled)

29. The method of claim 23, further comprising:
receiving, from the user via at the at least one communication network, authorization for the data product personalization service to obtain the at least some of the user data from the at least one data source;
obtaining the at least some of the user data from the at least one data source via the at least one communication network; and
storing the at least some of the user data in at least one datastore.

30-33. (canceled)
